(19) United States
(12) Patent Application Publication
(10) Pub. No.: US 2024/0300633 A1
(43) Pub. Date: Sep. 12, 2024

(54) ONBOARD HIGH VOLTAGE BATTERY CHARGING SYSTEM OF AN OUTBOARD MARINE PROPULSION SYSTEM

(71) Applicant: Flux Marine Ltd., Bristol, RI (US)

(72) Inventors: Benjamin Sorkin, Melville, NY (US); Jonathan Lord, Providence, RI (US); Linden Zlotea, Jamaica Plain, MA (US)

(21) Appl. No.: 18/666,376

(22) Filed: May 16, 2024

Related U.S. Application Data
(63) Continuation of application No. PCT/US2023/010586, filed on Jan. 11, 2023.
(60) Provisional application No. 63/298,504, filed on Jan. 11, 2022.
(60) Provisional application No. 63/298,521, filed on Jan. 11, 2022.
(60) Provisional application No. 63/298,498, filed on Jan. 11, 2022.
(60) Provisional application No. 63/298,511, filed on Jan. 11, 2022.
(60) Provisional application No. 63/298,518, filed on Jan. 11, 2022.

(51) Int. Cl. B63H 20/28; B60L 53/302; B60L 58/26; B63H 20/14; B63H 20/32

(52) U.S. Cl. CPC B63H 20/28; B60L 53/302; B60L 58/26; B63H 20/14; B60L 2200/32; B63H 2020/323

(57) ABSTRACT

A heat transfer apparatus including a reservoir, a pump fluidically coupled to the reservoir, a splitter fluidically coupled to the pump and coupled to a plurality of fluid flows. The heat transfer apparatus includes a first temperature sensor disposed between the pump and the splitter, and for each of the plurality of fluid flows: an adjustable valve, a motor fluidically coupled to the adjustable valve, a second temperature sensor integrated into the motor and a third temperature sensor disposed after the motor. The heat transfer apparatus includes a combiner fluidically coupled to each of the fluid flows, a fourth temperature sensor disposed after the combiner, and a heat sink fluidically coupled to the combiner and the reservoir wherein the second temperature sensor is configured to provide a control signal to a control unit to control fluid flow through the adjustable valve.

### CROSS-REFERENCE TO RELATED APPLICATION

This application is a Continuation of, and claims the benefit of priority under 35 USC 120 to Patent Cooperation Treaty Patent Application No. PCT/US23/10586 filed Jan. 11, 2023, which claims the benefit of priority to U.S. Provisional Patent Application Nos. 63/298,504, 63/298,521, 63/298498, 63/298511, 63/298518, each of which were filed on Jan. 11, 2022. Each of these applications are hereby incorporated by reference in their entirety.

### FIELD OF THE DISCLOSURE

This disclosure is directed toward a marine propulsion system. More particularly, a housing structure for power transmission, optimized heat transfer, lubrication and battery charging with cooling of a marine propulsion system.

### BACKGROUND

Marine Propulsion engines have historically been categorized into three general types: inboard marine propulsion systems, outboard marine propulsion systems, and sterndrive, or, inboard/outdrive marine propulsion systems.

Inboard propulsion systems comprise a prime mover that uses an energy source to convert energy into rotational motion of a shaft or shafts, a transmission that conveys that rotational power to a propeller shaft which protrudes from the bottom of a boat hull. A propeller is fastened to the end of that submerged shaft and generates thrust, which is directed by a rudder, usually located aft of the propeller. An outboard engine generally comprises a powerhead with a prime mover, a lower unit, or gearcase that houses a propeller and shaft, and a midsection that provides physical connection between the powerhead and lower unit while allowing a power transmission device to transfer power from the prime mover to propeller shaft. The entirety of the outboard engine mounts to the transom of a boat and can be removed. Sterndrive systems, also called inboard/outboard, or drive systems, house the prime mover inside of the boat. The shaft of the prime mover is connected to an outdrive transmission that transmits power to a lower unit or gearcase.

Sterndrive and outboard marine propulsion systems traditionally use a set of right-angle bevel gears to transmit rotational power from a prime mover to the propeller. An additional gear set is used in the case of combustion engines to enable reversing rotation.

A variety of power transmission methods is known from prior art, including belt or chain transmission arrangements. Synchronous belts have become strong and durable, enabling potential use in higher power marine engine transmissions. Implementation of such belt technologies present challenges in physical housing arrangements and mechanical assembly. Frontal area and hydrodynamic shape of submerged portions of marine propulsion systems greatly affects system drag and efficiency. Accommodating belt drive technologies with traditional physical architecture that was designed to house rotating shafts and gears creates hurdles in overall efficient design.

A byproduct of power generation and power transmission is waste heat. Failure to sufficiently dissipate waste heat can lead to catastrophic failure, including, but not limited to thermal runaway or system shut down. Historically, electric vehicle thermal management systems have had limited capabilities, been overly complex, or both. For example, early generation electric vehicles often used multiple independent heat management subsystems. Such an approach is inherently inefficient as each heat management subsystem requires its own components (e.g., pumps, valves, refrigerant systems, etc.). This has direct impedance on total system efficiency and therefore range in the case of electric vehicles. Alternatively, a single loop with each component can be connected in series to one another. This method places permanent priority to certain components, regardless of immediate need and increases overall back pressure of the system, therefore requiring additional power to the circulation pump. Typically, a propulsion system will utilize either a closed loop system or an open loop system. An open loop system will intake fluid from an exterior body of water and circulate around select components to dissipate heat. An open loop system may include internal closed loop cooling circuits with the use of heat exchangers. Other propulsion systems utilize a totally closed loop cooling system. A closed loop system generally includes a coolant flow loop of some number of waste heat generating components, at least one heat exchanger, a pump, valves, and a reservoir. Both open and closed loop systems have benefits and drawbacks.

An open system is simpler, as it transfers waste thermal energy directly from components to the open-source coolant loop. Drawbacks of open systems include a tendency to become blocked if intakes are covered, and that oil or other contaminants that can easily enter the coolant flow thereby causing environmental impact. Moreover, when salt water is used for cooling, it can rapidly corrode sensitive components. Therefore, it is a common requirement to be flushed on a regular basis. Benefits of a closed loop system include applicability to propulsion systems other than marine applications such as automotive and aerospace. Other benefits include ability to use a particular working fluid. Drawbacks include restricted ability to scale heat dissipation as the heat sink must scale with the waste heat generation. By comparison, an open system need only increase the flow rate.

Embodiments of the present disclosure are intended to address the above challenges as well as others.

Gear reduction systems are a common requisite in traction drives and other propulsion systems. A gear reduction system helps to align the torque/power curve of a prime mover with the output shaft speed requirements. For combustion and electric motors, the power output is limited while operating at low RPM ranges for the system. In turn, a gear reduction provides higher toque for the same output toque. Common examples include transmissions for automotive vehicles, designed to allow the engine to operate at an efficient RPM while maintaining control of the output shaft.

An epicyclic gear box or gearbox (also referred to as a “gearset”) generally transforms the rotation input to either a slower rotating shaft with more torque or to a faster rotating shaft with lower torque. In some gearboxes, straight cut spur gears are used with involute teeth. Other gearing systems may use different tooth profiles or non-spur gears. Electric motors can achieve higher operational efficiency by spinning at higher RPMs. By pairing with a gear reduction, a high efficiency of the motor can be achieved while maintaining sufficient torque at low speeds. The reduction ratio is determined by the relative tooth count of the present gears.

Gear reduction systems are a common requisite in traction drives and other propulsion systems. A gear reduction system helps to align the torque/power curve of a prime mover with the output shaft speed requirements. For combustion and electric motors, the power output is limited while operating at low RPM ranges for the system. In turn, a gear reduction provides higher toque for the same motor output toque. Common examples include transmissions for automotive vehicles, designed to allow the engine to operate at an efficient RPM while maintaining control of the output shaft.

An epicyclic gear box comprises an outer ring gear, a central sun gear, smaller planet gears and a planet carrier. The function of the gearbox is to transform the rotation input to either a slower rotating shaft with more torque or to a faster rotating shaft with lower torque. Losses during power transmission are inevitable. Some examples of losses are: 1) Rolling losses 2) Sliding losses 3) Gliding losses 4) Bearing losses. Reducing the losses of the system will increase the system efficiency of the drivetrain. Losses that occur typically take the form of waste heat. This waste heat must be sufficiently rejected from the gearbox to stop damage occurring due to overheating. Some solutions for gearbox cooling may use either 1) Fan cooling—mounted to the high speed shaft to keep air flowing over the outer housing 2) Water cooling—a water jacket is mounted to the radial housing 3) Oil-to-water cooling—uses a separate heat exchanger to transfer waste heat from the gears to the oil to the water. These methods are progressively more effective, however each more complicated than the previous.

The power transmitted by a shaft is proportional to the torque applied and the rotational speed (RPM). An epicyclic gear reduction has an upper power limit due to two main limiting factors. One limiting the maximum torque and the second limiting the maximum RPM. The material properties have a limit to the torque transmitted. If the torque limit is exceeded, the material will deform and break. This is likely to occur at the teeth of the gears or splines where the loading is highest. Thermal loading limits the ability to increase RPM indefinitely. Generally, the bearings are the first component to put a limit on maximum RPM. If bearings overheat, they can undergo friction welding, causing lubricating oil to burn, reducing levels of oil, and/or reducing the ability to lubricate. Current solutions to these challenges include using complex heat treatment processes to increase the strength of the material and therefore the torque capability. Other solutions include using advanced materials such as ceramics, which are very heat resistant. This is used in applications such as gas turbine bearings, where speeds can be in excess of 100,000 RPM and temperatures reaching 1000 K. Excessively high prices for these solutions limit mass adoption. Typical methods of cooling and lubricating gear reducers is to submerge in oil and circulate the oil through a radiator or heat sink. This is inefficient as it requires a circulation system of its own.

A variety of power transmission methods exist, including drive shaft, belt, chain, or direct drive transmission arrangements. Sterndrive and outboard marine propulsion systems traditionally use a drive shaft with a set of right-angle bevel gears to transmit rotational power from a prime mover to the propeller. An additional gear set is used in the case of combustion engines to enable reversing rotation. Drive shafts with bevel gears at the bottom are particularly conducive to a vertical power output from the powerhead, allowing a large engine to be centered above the lower unit. However, drive shafts also suffer from higher frictional losses than other methods. Direct drive systems are popular with many small electric outboard systems, where the motor is mounted in the lower unit and is directly connected to the propeller. This is possible because of the smaller size of electric motors as compared to combustion engines, but this engine geometry presents issues for larger, more powerful motors as the frontal area and hydrodynamic shape of submerged motor would cause significant drag.

Synchronous belts have become strong and durable, enabling potential use in higher power marine engine transmissions. Implementation of such belt technologies present challenges in physical housing arrangements and mechanical assembly. Two significant hurdles to overcome when using a belt drive in an outboard engine are the need to keep the belt under tension, and the tendency for the belt to shift along pulleys if shafts are not properly aligned. Tension may be added to the belt by increasing the distance it must travel between pulleys, either by physically moving the pulleys apart, or by deflecting the belt with an idler pulley. Tension is needed in the belt to prevent slipping or skipping teeth when under load. The amount of tension required to allow a belt to function properly is proportional to the torque applied to the sprockets and the size of the sprockets. Despite the added friction, idler pulleys have so far been ubiquitous for belt drives in marine propulsion applications due to the difficulty of moving either the propeller shaft or the primary mover and powerhead without sacrificing either shaft alignment or waterproofing.

The primary losses in synchronous belts result from friction between the belt and sprockets as well as within bearings that the prime mover and propeller shaft rotate on. Tension in belt adds a significant radial load which increases the friction experienced by the drivetrain. While this issue can be somewhat alleviated using sprockets with a greater diameter and more teeth, this is often impractical as it could lead to hydrodynamic losses.

The battery charger of a battery electric vehicle serves to take alternating current (AC) power that is provided by the electrical grid and convert it to direct current (DC) power that can be stored in a battery. The grid uses AC power for ease of transmission, but only DC power can be stored in a chemical battery. Separate battery chargers are used in situations where either it is desirable to reduce the amount of equipment within an electric vehicle, or for higher power applications where the size and cost of the charger becomes infeasible to include within the electric vehicle.

A byproduct of power generation, power conversion, and power transmission is waste heat. Failure to sufficiently dissipate waste heat can lead to catastrophic failure, including but not limited to thermal runaway or system shut down. Historically, marine electric vehicle outboard thermal management systems primarily serve to cool the motor and inverter that are found within the outboard engine. Batteries and the battery charger generally either have their own thermal management system, or do not require active cooling. One very common design has the battery charger as a separate component that is plugged into the marine propulsion system only when in use. This comes with the advantage of being able to leave the charger behind, reducing weight. The disadvantages are that batteries cannot be charged without this additional piece of equipment which if brought along will be heavier than its integrated equivalent. A detached battery charger must have its own thermal management system as heat dissipation is often a leading factor in how much power can be delivered to the batteries.

Embodiments of the present disclosure are intended to address the above challenges as well as others.

### BRIEF SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a heat transfer apparatus including a reservoir configured to contain a working fluid, a pump fluidically coupled to the reservoir, a splitter fluidically coupled to the pump and coupled to a plurality of fluid flows, a first temperature sensor disposed between the pump and the splitter, the first temperature sensor configured to measure a first temperature of the working fluid. For each of the plurality of fluid flows an adjustable valve, a motor fluidically coupled to the adjustable valve, a second temperature sensor integrated into the motor, the second temperature sensor configured to measure a second temperature of the motor, a third temperature sensor disposed after the motor, the third temperature sensor configured to measure a third temperature of the working fluid, a combiner fluidically coupled to each of the plurality of fluid flows and configured to combine each of the plurality of fluid flows, a fourth temperature sensor disposed after the combiner, the fourth temperature sensor configured to measure a fourth temperature of the working fluid and a heat sink fluidically coupled to the combiner and the reservoir. Wherein the second temperature sensor is configured to provide a control signal to a control unit to thereby control fluid flow through the adjustable valve.

In some embodiments, the heat transfer apparatus is integrated into a marine propulsion system.

In some embodiments at least one motor is coupled to an inverter.

In some embodiments at least one motor is coupled to a charger.

In some embodiments a fifth temperature sensor disposed after the heat sink, the fifth temperature sensor configured to measure a fifth temperature of the working fluid. In some embodiments, the adjustable valve is a continuously adjustable valve. In some embodiments, the working fluid is a refrigerant. In some embodiments, the working fluid is a water-glycol mix. In some embodiments, the splitter is a manifold. In some embodiments, the multiple outputs of the splitter are each coupled to an adjustable valve, each of the adjustable valves further comprising a flow sensor. In some embodiments, each of the adjustable valves are individually controlled.

To achieve these and other advantages and in accordance with the purpose of the disclosed subject matter, as embodied and broadly described, the disclosed subject matter includes a gearing system includes a motor having a shaft, the shaft extending from the motor to a terminal end external to the motor, a planetary gear set comprising a sun gear, two or more planet gears coupled to a carrier, and a ring gear, the planetary gear set having a proximal side facing towards the motor and a distal side facing away from the motor, wherein the sun gear is disposed on the distal side, a housing enclosing the planetary gearset, the housing coupled to the ring gear. Wherein the axle extends at least partially through the housing and the planetary gearset, and the shaft is coupled to the sun gear and when the shaft rotates at a first revolutions per minute (RPM), the housing rotates at a second RPM that is less than the first RPM.

In some embodiments, wherein the gearing system further comprising a spacer disposed on the shaft and between the planetary gear set and the motor.

In some embodiments, the carrier is coupled to the spacer.

In some embodiments a ratio between the first RPM and the second RPM is 2.

To achieve these and other advantages and in accordance with the purpose of the disclosed subject matter, as embodied and broadly described, the disclosed subject matter includes a system, the system including a motor, an input shaft extending from the motor to a terminal end, a planetary gearset adjacent and in contact with the reservoir, the planetary gearset comprising a sun gear, two or more planet gears coupled to a carrier, a ring gear, and an output shaft. Wherein the input shaft is coupled to the sun gear and the output shaft is coupled to the carrier and a reservoir disposed between the motor and the planetary gearset, the reservoir comprising a toroidal shape around the input shaft, wherein the reservoir is fluidically isolated from the shaft and the planetary gearset.

To achieve these and other advantages and in accordance with the purpose of the disclosed subject matter, as embodied and broadly described, the disclosed subject matter includes a marine propulsion apparatus including a first drive shaft, a lifting plate fixed relative to the first drive shaft, a midsection top collar, a first strut extending from a proximal end to a distal end and a second strut extending from a proximal end to a distal end, each of the first strut and the second strut having an interior belt void, wherein the first strut is aligned with the second

strut and the first strut is spaced from the second strut, wherein the proximal ends of the first strut and the second strut are coupled to the midsection top collar, a lower unit coupled to the distal ends of the first strut and the second strut, the lower unit having a second drive shaft, wherein the midsection top collar is fixed relative to the second drive shaft, a belt rotatably coupling the first drive shaft to the second drive shaft, wherein a first portion of the belt is disposed within the interior belt void of the first strut and a second portion of the belt is disposed within the interior belt void of the second strut, one or more lifting screws coupling the lifting plate to the midsection top collar, wherein adjusting the one or more lifting screws changes a distance between the lifting plate and the midsection top collar, thereby adjusting a tension of the belt, and an actuator disposed on each of the one or more lifting screws.

In some embodiments, the marine propulsion system further includes a lifting platform disposed between the lifting plate and the midsection top collar and a load cell contacting the lifting plate and the lifting platform.

To achieve these and other advantages and in accordance with the purpose of the disclosed subject matter, as embodied and broadly described, the disclosed subject matter includes a system, the system further including an electric boat motor, a lower unit coupled to the electric boat motor, the lower unit comprising a propeller, an inverter, an onboard battery charger coupled to the inverter and one or more high-voltage batteries and a heat transfer circuit. The heat transfer circuit including a reservoir having a working fluid, a pump, a valve, a first tube fluidically coupling the reservoir to the pump, a second tube fluidically coupling the pump to the valve, a third tube fluidically coupling the valve to the inverter, a fourth tube fluidically coupling the valve to the onboard battery charger, a fifth tube fluidically coupling the inverter to the motor, a sixth tube fluidically coupling motor to the lower unit, a seventh tube fluidically coupling the onboard battery charger to the sixth tube, an eighth tube fluidically coupling the lower unit to the reservoir. Wherein when in a charging configuration, the valve allows working fluid to flow through the fourth tube to the onboard battery charger and when in an operational configuration, the valve does not allow working fluid to flow through the fourth tube.

To achieve these and other advantages and in accordance with the purpose of the disclosed subject matter, as embodied and broadly described, the disclosed subject matter includes a method of recharging an electric boat, the method includes providing an electric boat having a hull, an outboard motor coupled to the hull, and one or more rechargeable batteries disposed within the hull, wherein the outboard motor comprises an electric motor and an onboard battery charger and coupling the onboard battery charger to a source of alternating current thereby causing the one or more rechargeable batteries to charge.

### BRIEF DESCRIPTION OF THE SEVERAL VIEWS OF THE DRAWINGS

FIG. 1 illustrates an isometric view of an outboard motor according to embodiments of the present disclosure.

FIG. 2 a block diagram representing component level interactions between the propulsion system as a whole and the dual strut lower unit according to embodiments of the present disclosure.

FIG. 3 illustrates a partial side view of the dual strut and lower unit bullet architecture taken generally below the line 1-1 of FIG. 1 according to embodiments of the present disclosure.

FIG. 4 illustrates a partial front view taken generally below the line 1-1 of FIG. 1 according to embodiments of the present disclosure.

FIG. 5 illustrates a cross-sectional side view taken generally below the line 3-1 of FIG. 3 according to embodiments of the present disclosure.

FIG. 6 illustrates a cross-sectional top view taken generally below the line 3-1 of FIG. 3 according to embodiments of the present disclosure.

FIG. 7 illustrates a cross-sectional front view taken generally below the line 3-1 of FIG. 3 according to embodiments of the present disclosure.

FIG. 8 illustrates a schematic representation of an outboard power transmission system according to embodiments of the present disclosure.

FIG. 9 illustrates a schematic representation of a belt-drive transmission system according to embodiments of the present disclosure.

FIGS. 10A-10B illustrate a computational fluid dynamics visualization of a dual strut and a single strut according to embodiments of the present disclosure.

FIG. 11 illustrates a graphical representation of initial computational fluid dynamics drag results of a dual strut (left) compared to a single strut (right) according to embodiments of the present disclosure.

FIG. 12 illustrates a diagram of a cooling loop system with three heat generating components in parallel in accordance with an embodiment of the present disclosure.

FIG. 13 illustrates a diagram of a cooling loop system operating to cool a high-temperature charger in charge mode in accordance with an embodiment of the present disclosure.

FIG. 14 illustrates a diagram of a cooling loop system operating to cool a high-temperature motor and inverter, bypassing the charger in accordance with an embodiment of the present disclosure.

FIG. 15 illustrates a cross-sectional view of a planetary gear set with a 3:1 gear ratio when constraining the ring gear in accordance with an embodiment of the present disclosure.

FIG. 16 illustrates a cross-sectional view of a gear box and motor in accordance with an embodiment of the present disclosure.

FIG. 17 illustrates an isolated, exploded, sectional half view of the planetary gearset and a spacer in accordance with an embodiment of the present disclosure.

18 illustrates an isometric sectional half view of the gear reduction assembly with input motor and spacer removed for clarity in accordance with an embodiment of the present disclosure.

FIG. 19 illustrates a planetary gearbox in accordance with an embodiment of the present disclosure.

FIG. 20A illustrates a motor having a shaft with a spacer coupled to the exterior of the motor 200 in accordance with an embodiment of the present disclosure. FIG. 20B illustrates a planetary gearset, spacer, and a motor in accordance with an embodiment of the present disclosure.

FIG. 21A illustrates a cross-sectional view of a planetary gearset, a spacer, and a motor in accordance with an embodiment of the present disclosure. FIG. 21B illustrates a cross-sectional view of a gearset housing coupled to the carrier and a motor in accordance with an embodiment of the present disclosure.

FIG. 22A illustrates a cross-sectional view of a planetary gearset in accordance with an embodiment of the present disclosure. FIG. 22B illustrates a cross-sectional view of a planetary gearset and gearset spacer in accordance with an embodiment of the present disclosure.

FIG. 23 illustrates a gearbox housing with the output spline highlighted in accordance with an embodiment of the present disclosure.

FIG. 24 illustrates a planetary gearbox in accordance with an embodiment of the present disclosure.

FIG. 25 illustrates a cross-sectional view of a gear box and motor in accordance with an embodiment of the present disclosure.

FIG. 26 illustrates an isometric, sectional view of the gearbox with input and output shaft hidden for clarity in accordance with an embodiment of the present disclosure.

FIG. 27 illustrates a side view that includes the tensioning mechanism, powerhead, part of the midsection, the belt, and the propeller shaft in accordance with an embodiment of the present disclosure.

FIG. 28A illustrates a top view of the powerhead and midsection top collar with the power electronics removed in accordance with an embodiment of the present disclosure. FIG. 28B illustrates a cross-sectional view of the belt and motor shaft in accordance with an embodiment of the present disclosure.

FIG. 29 illustrates a close-up view of a lifting screw with sensor and actuator in accordance with an embodiment of the present disclosure.

FIG. 30 illustrates an isometric view of an outboard motor with various components removed to illustrate the cooling loop in accordance with an embodiment of the present disclosure.

FIG. 31 illustrates an isometric view of an outboard motor powerhead with various components removed to illustrate the cooling loop in accordance with an embodiment of the present disclosure.

FIG. 32 illustrates an isometric view of an outboard motor and boat with onboard battery charger (OBC) and high voltage batteries highlighted in accordance with an embodiment of the present disclosure.

### DETAILED DESCRIPTION

The powertrain of an outboard motor generally includes a prime mover, such as a combustion engine or electric motor, a vertical drive shaft, bevel gear, clutch, and propeller shaft (to which a propeller is attached). Bevel gears are gears between two intersecting shafts where the tooth-bearing faces of the gears are conical in shape. Bevel gears offer higher efficiency than other gear options and may allow for a gear reduction between the intersecting shafts. A clutch is used to allow the prime mover to operate in a single direction but also may allow the propeller shaft to rotate in both clockwise and counterclockwise directions. In various embodiments, outboards may use a dog clutch to switch between forward, neutral and reverse. This requires engaging and disengaging the shifting gears, leading to expedited wear on the teeth of the gear. To minimize this wear, the entire assembly may be submerged in an oil or lubricant that can be harmful to the environment and difficult to dispose of. Heat dissipation from key components including but not limited to, the prime mover, gears and bearings may be integral for reliable operation of this type of outboard motor. Outboard motors may ingest fluid (e.g., sea water) from the body of fluid (e.g., the sea) in which it operates to circulate the fluid around the system and cool components. However, this external fluid intake can bring in contaminants, including but not limited to salt, sand, and/or dirt that can expedite the wear and corrosion process. In some embodiments, the prime mover may be housed within the lower unit, below the water line. This configuration brings advantages with simplicity but may limit heat transfer capability. In various embodiments, other means of power transmission in place of a vertical drive shaft and bevel gears include, for example, chain-driven and belt-driven systems. In various embodiments, synchronous belts may be strong and durable, enabling potential use in higher power marine engine transmissions. In various embodiments, implementation of such belt or chain technologies may present challenges in physical housing arrangements and mechanical assembly as frontal area and hydrodynamic shape of submerged portions of marine propulsion systems greatly affects system drag and efficiency.

Accordingly, marine propulsion systems are needed that are optimized for belt-driven and chain-driven motors while reducing drag (e.g., improving hydrodynamic qualities) and improving heat dissipation. Embodiments of the present disclosure are intended to address the above challenges as well as others.

In various embodiments, a sterndrive or outboard marine propulsion system includes a prime mover that transmits power to a driven shaft through a synchronous belt, an anti-ventilation plate, a lower unit housing, one or more skegs extending from the bottom of the lower unit housing, and a set of struts (e.g., two struts) that connects the lower unit housing to the anti-ventilation plate and attachment point on the cowling (and/or frame structure within the cowling). In various embodiments, the set of struts may be substantially aligned (e.g., parallel) with one another. In various embodiments, each strut may include one or more (e.g., a plurality) of removably attachable and modular trailing edge pieces. In various embodiments, removably attachable trailing edge pieces may allow for fine tuning of hydrodynamic properties.

In various embodiments, the attachment point connects the midsection to the lower unit and prime mover in the embodiment of an outboard marine propulsion system or connects the lower unit and outdrive in the case of a sterndrive marine propulsion system. In various embodiments, particular variables of the system enable lower drag, higher performance, and efficient accommodation of belt drive technologies. In various embodiments, components of the marine propulsion system may be modular, replaceable, and/or built such they have integrated cooling channels. In various embodiments, integration of heat dissipation functionality into a multi-strut (e.g., dual-strut) architecture may provide increased surface area from the multiple struts to optimize heat transfer capability. In various embodiments, multiple struts (e.g., two struts) increases the surface area of the struts in contact with water, thereby improving heat transfer (e.g., conduction) with the water (similar to the heat transfer of fins). One of ordinary skill in the art would appreciate that there are configurations of struts in sets that may be utilized for this purpose. For example two, four, six or eight strut configurations. In various embodiments there may be struts that are for structure only and struts that operate to house one or more belts or chains for driving motor.

In various embodiments, frontal area and hydrodynamic shape of submerged portions of marine propulsion systems may affects system drag and efficiency. Reducing the drag on a marine propulsion system has direct improvement on the net efficiency of the system. In various embodiments, as the set of struts may be submerged when in use, the set of struts may have any suitable hydrodynamic shape to thereby reduce and/or optimize drag. For example, each strut may include an airfoil shape where the leading edge of the airfoil corresponds to the leading side of the strut. In various embodiments the struts may be hydrodynamically optimized such as a hull shape or teardrop shape in cross section or part. When in operation, a belt has a tight side and a slack side. In various embodiments, the belt may be isolated (i.e., sealed) from the surrounding body of water in which the motor operates. In various embodiments, both sides of the belt may be supported to provide tension to the belt. In various embodiments, providing tension to the belt may reduce (e.g., stop) contamination from the surrounding water. In various embodiments, the marine propulsion system may include, among other things, a continuous loop power transmission device. For example, the prime mover may be mechanically (e.g., rotationally) coupled to the propeller via a belt or chain. The continuous loop power transmission device may include one or more belts or chains, alone or in combination to transmit power through the system. The belts and/or chains may be selectively or actively slack-controlled, such as to maintain efficiency.

In various embodiments, each strut may be positioned at a predetermined distance from one another to thereby allow fluid flow between the struts. For example, in a dual-strut arrangement, the struts may be positioned about 2 to about 24 inches from one another, in various embodiments. In various embodiments, the struts may be positioned about 1.5 to 6 inches from one another. In various embodiments, in larger applications (e.g., yachts, tugboats, etc.), the struts may be positioned several feet apart. In various embodiments, the struts may be positioned up to about 12 feet apart. In various embodiments, the spacing of the struts may be dependent on one or more performance factors, such as, e.g., (1) hydrodynamic interactions between the struts and/or (2) hydrodynamic drag of the lower unit. In various embodiments, the struts may be horizontally spaced. In various embodiments the struts may be both horizontally and longitudinally (i.e., the direction of locomotion of the motor) spaced apart or offset. In various embodiments the struts may be of varying size and shape, such that a set of struts include differing hydrodynamics between sets. In various embodiments the shape of the struts may vary along their vertical length, such that the cross-sectional shape of the strut varies according to depth or vertical location on strut. In various embodiments, as struts become wider, fewer fluid interactions may occur between the multiple struts (interference). In various embodiments, wider struts may improve certain performance factors. In various embodiments, the size (e.g., drag area) of the lower unit may be minimized to thereby minimize drag. In various embodiments, the size of the lower unit may be minimized by providing a small frontal area of the lower unit. In various embodiments, the size of the lower unit may be proportional to the size of the struts. For example, for wider struts, a larger lower unit may be provided. In various embodiments, the struts may not be parallel. For example, the struts may be non-linear or disposed at an angle (e.g., a ‘V’ shape) with respect to the horizontal (sea surface level).

In various embodiments, each strut may include a cross-sectional profile of the vertical struts that minimizes the drag through water. In various embodiments, the cross-sectional profile may reduce (e.g., minimize) the drag area while allowing for enough void space to house the continuous loop (e.g., belt or chain). In various embodiments, each strut may include an airfoil shape. In various embodiments, any struts (e.g., some or all struts) may have a substantially uniform shape along its length. In various embodiments, any struts (e.g., some or all struts) may have a varying shape along its respective length. For example, a strut may taper, from the leading to trailing edges, from a wider airfoil (having a higher drag area) to a thinner airfoil (having a lower drag area) or vice versa. In various embodiments, any struts (e.g., some or all struts) may have a substantially uniform width (in the direction of flow) along the length of the strut. For example, an airfoil shape may have a substantially similar (e.g., equal) chord length and/or camber line along the entire length of the strut. In various embodiments, any struts (e.g., some or all struts) may have a varying width (in the direction of flow) along the length of the strut. For example, an airfoil shape may have a varying chord length and/or camber line along the entire length of the strut. The struts can have mirroring shapes that are symmetrical about a central axis passing through the struts; alternatively, each strut can be formed with a unique shape/profile relative to the adjacent strut. In various embodiments the struts may include internal structural features such as beams or webbing. In various embodiments the struts may be additively manufactured (e.g., 3D printed). In various embodiments the struts may be machined from metal stock. In various embodiments the struts may be casted, molded, or formed from composite or another material.

In various embodiments, each strut may include separate void spaces configured to house each side of the continuous loop (i.e., the slack side and the taut side). In various embodiments, the separate void spaces within either one or all of the vertical struts may be configured to transfer fluid (e.g., a heat transfer fluid) throughout the outboard.

In various embodiments, one or more of the struts may include a parting line to thereby separate the strut into two or more pieces. In various embodiments, parting lines allow for ease of access so that a continuous loop (e.g., chain or belt) may be installed or removed during or after manufacture (e.g., for repairs). The parting line(s) can be extend along the entire portion of the strut (e.g. between nosecone and anti-ventilation plate).

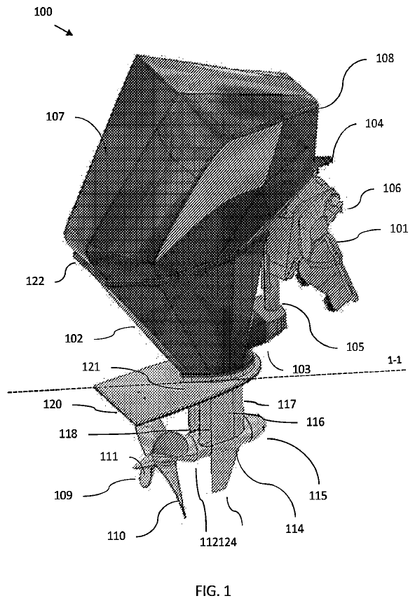

FIG. 1 illustrates an isometric view of an outboard marine propulsion system 100. In various embodiments, the marine propulsion system 100 (e.g., an outboard motor) may include a powerhead section, prime mover cowling, belt drive, anti-ventilation plate, dual strut transmission housing, lower unit with propeller, and skeg. In various embodiments, the outboard marine propulsion system 100 includes a mount 101 configured to releasably couple the transom of a boat to the outboard midsection 102 via a transom mount pad 103. In various embodiments, the outboard motor may be steered through a variety of methods, including but not limited to cables, pulleys, hydraulic and/or electromechanical actuators that mount to the steering bracket 104 and rotate the outboard motor around an axis of the steering tube 105. In various embodiments, the angle of the outboard motor, and thus the angle of propulsion, can also be controlled around the tilt axis 106. In various embodiments, the prime mover components, whether electrically or liquid fuel powered, are located underneath the top cowling 107. In various embodiments, a side of the cowling 107 facing the transom of the boat may include a face plate 108. In various embodiments, the drive shaft of the prime mover is connected via a synchronous drive belt (not shown) to the propeller shaft 109. In various embodiments, the synchronous drive belt, in turn, drives the propeller 110, creating momentum to propel the boat on which the marine propulsion system 100 is affixed. In other embodiments, the propeller may be replaced by an impeller, waterjet, or other propulsive device. In this embodiment, a propeller tailcone 111 and tail fairing 112 match the geometric profile of the propeller to minimize turbulent losses and maximize efficiency. In other embodiments, the propeller tailcone 111 and tail fairing 112 shapes can be adjusted to match different propellers. A sprocket (disposed inside the lower unit) is concentrically mounted to the propeller shaft 109 and housed inside the lower unit 114. In various embodiments, the lower unit 114 may include a nosecone 115 on a leading portion thereof. The one or more struts 116 provide an open pathway for the belt to transmit power from a sprocket attached to the prime mover under the top cowling 107 to the sprocket on the propeller shaft 109. The separate struts 116 bodies allow for the belt to operate without additional rolling components, enabling the highest possible efficiency. The one or more struts 116 are spaced in such a way that the belt does not need to be guided around obstacles or shapes as it has been required to do so in prior art. The strut bodies have hydrodynamic strut leading edges 117 and strut trailing edges 118 that reduce drag and maximize laminar flow to the propeller 110. The struts 116 connect to the anti-ventilation plate 120, which is fastened to the midsection bottom collar 121. This, in turn, fastens to the bottom of the midsection. In various embodiments, a midsection top collar 122 may provide an interface between the midsection 102 and the top cowling 107. In various embodiments, one or more skeg 124 is disposed below the lower unit. In various embodiments, where two or more skegs are provided, each skeg may be positioned equiangularly around the lower unit 114, and located upstream of the propeller.

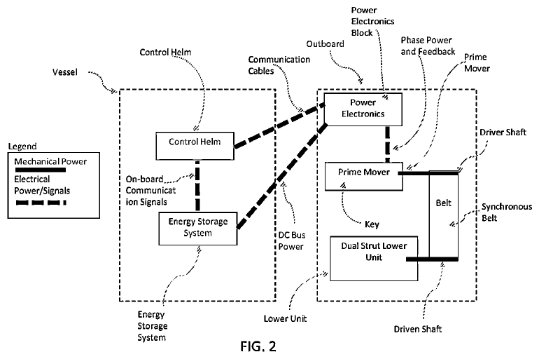

FIG. 2 illustrates a block diagram 200 representing component level interactions between the propulsion system as a whole and the dual strut lower unit. Component blocks are generally located in either the vessel or in the outboard, and are connected either mechanically or electrically as indicated by the legend. In various embodiments, the operator controls the system via the control helm, which uses on-board communication signals to interface with the energy storage system and additional communication cables to interface with the power electronics in the outboard. Communication protocols including, but not limited to, serial, CANbus, SPI, analog, and digital could be used. In various embodiments, the Energy Storage System is connected to the power electronics block through a DC Bus. In various embodiments, the DC bus may range from 12V to over 900V. In various embodiments, the power electronics block generally encompasses all power stage and control components required to use DC voltage to drive a prime mover. In various embodiments, based on signals from the control helm, the power electronics may pull energy from the Energy Storage System through the DC Bus and control the prime mover. In various embodiments, the prime mover may be an electric motor, through Phase Power and Feedback signals. In various embodiments, the prime mover is mechanically coupled through a driver shaft to the synchronous belt. In various embodiments, the belt rotates a driven shaft located inside the lower unit to thereby power a propeller.

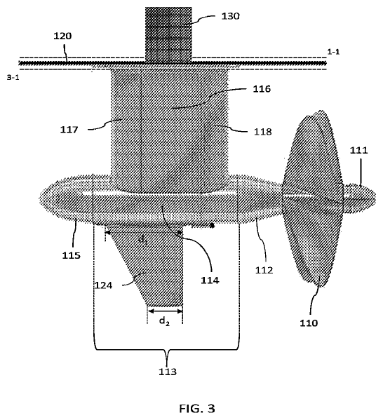

FIG. 3 illustrates a partial side view of the dual strut and lower unit bullet architecture taken generally below the line 1-1 of FIG. 1. Line 1-1, in some embodiments, is the water line of the outboard during operation. When in operation, all components below the waterline 1-1 are submerged and contribute to the hydrodynamic drag of the system. As described in the background, sterndrives and outboard marine propulsion systems may use single strut housings that connect gearcases to powerheads. Additionally, nearly all combustion outboards use a shaft and bevel gear system to transmit power from the combustion or electric powerhead to the propeller. In that type of lower unit, a mechanical mechanism is required for switching from forward to neutral to reverse. This type of power transmission requires consistent maintenance for lubricating the gears, wears quickly because of shifting at non-zero rotational speed, and may result in a 15% efficiency loss. The bevel gears also generate significant noise.

Recent advancements in material technologies have enabled the development of more robust synchronous belt drives which have the potential to increase efficiency, decrease noise, reduce maintenance, and lower cost. The present disclosure enables the use of a synchronous belt in a marine propulsion system, through a multi-strut body arrangement where each side of the belt travels through a different strut. Additionally, the present disclosure also provides a method for using electronic reversing from an electric prime mover, thereby eliminating the need for a complex mechanical shifting solution.

In various embodiments, the multi-strut design minimizes fluid flow obstruction to the propeller while moving. In various embodiments, the multi-strut (e.g., dual-strut) design reduces drag-inducing frontal area (i.e., the drag area) while increasing robustness of the entire system. In various embodiments, the strut 116 and anti-ventilation plate 120 interface is integrally formed. In various embodiments, the strut 116 and anti-ventilation plate 120 interface is mechanically fastened (e.g., with bolts and nuts). In various embodiments, the bottom of the struts may be integrally formed with the lower unit 114. In various embodiments, the lower unit 114 may be bullet-shaped (a bullet + bullet casing). In various embodiments, a first portion (e.g., the taut side) and a second portion (e.g., the slack side) of a synchronous belt 130 is protected from water and/or external fluids inside a void space within first and second struts 116. Thus the belt 130 extends (vertically when in operation) through the first strut 116, into the lower unit 114, where it engages and drives the propeller 110 forward/reverse), and up through the second strut 116, and back into the cowling 107.

In various embodiments, drag may be reduced through hydrodynamic shapes applied to the leading edges 117 and trailing edges 118 of the struts 116. In various embodiments, convex surfaces on the sides of the struts 116 between the leading edges 117 and the trailing edges 118 reduce form drag and wave creation. In various embodiments, the profile of the convex surfaces does not have to be symmetric between struts and could be changed for different applications (i.e., not all struts have to be identical in shape). In various embodiments, struts 116 may be reflections of one another (e.g., a first strut may be a reflection of a second strut). In various embodiments, the sides of the struts 116 may be substantially parallel and of equivalent lengths. In various embodiments, the struts could be non-parallel. In various embodiments, the space between the struts may increase or decrease over the height of the struts.

In various embodiments, the sides of the struts 116 may have no concavity. In various embodiments, the leading edges 117 can be integrally formed with the strut 116. In various embodiments, the leading edges 117 may be separately manufactured and removably fastened to the strut 116. In various embodiments, the trailing edges 118 may be integrally formed with the strut 116. In various embodiments, the trailing edges 118 may be separately manufactured and removably fastened (e.g., with a screw, bolt, etc.) to the strut 116 via, for example, a strut attachment point. In various embodiments, the leading edges 117 and/or the trailing edges 118 may be modular and swappable for performance optimization. Additionally or alternatively, the strut(s) can include an access panel to allow repair and inspection of the belt. The access panel can be spaced from the leading/trailing edge and located within the generally planar section of the strut(s).

In various embodiments, the strut(s) may include active control of surface shapes of the leading and/or trailing edges during operation. For example, an electronic control (e.g., real time or manual) may change a camber or chord length of an airfoil shape. In another example, an electronic control (e.g., real time or manual) may change a width (e.g., drag area) of an airfoil shape such that the continuous loop (e.g., belt) has enough room to operate in the void space.

Further aiding in hydrodynamic drag reduction and increasing propulsive efficiency is the overall shape of the architecture. In various embodiments, incoming fluid flow interacts with the nosecone 115 first. In various embodiments, the nosecone 115 geometry may be designed with a smooth transition from the nosecone 115 over the nosecone/lower unit interface and to the lower unit 114. In various embodiments, the nosecone 115 is removable and swappable. In various embodiments, the nosecone 115 may include any suitable shape. For example, the nosecone 115 may include a blunt bullet-like shape. In various embodiments, a middle portion 113 of the lower unit 114 may have a substantially cylindrical shape (e.g., a bullet casing shape). In another example, the nosecone 115 may be substantially conical with a sharper point. In various embodiments, as fluid flow passes the lower unit 114, the tail fairing 112 may minimize loss-inducing boundary layer separation over the tail fairing/lower unit interface as boundary layer separation may cause turbulent flow thus increasing pressure drag on the propulsion system 100. In various embodiments, the tail fairing 112 is shaped such that the tail fairing/propeller hub interface hydrodynamically meshes with the propeller hub to optimize flow entering the propeller. Thus, the struts 116, lower unit 114, nose cone 115 and tail faring 112 can be configured with a virtually seamless design in which there are no abrupt changes in size/shape/diameter, with the assembly of these components forming a continuous outer surface area to minimize drag.

In various embodiments, the tail fairing may be a frustoconical shape tapering from a larger diameter at the middle portion 113 to a smaller diameter at the propeller 110. In various embodiments, as the propeller 110 spins and generates regions of high and low pressure, flow is directed over a propeller tailcone 111 to reduce turbulent flow and thus further minimize drag on the propulsion system 100. In typical combustion-type marine engines, engine exhaust is generally directed down through a singular piece and out through the center of the propeller. The present disclosure eliminates this style of exhaust and allows for a more efficient overall hydrodynamic approach.

In various embodiments, one or more skeg 124 may be attached to the middle portion 113 of the lower unit 114. In various embodiments, the middle portion 113 may include one or more skeg attachment points configured to allow attachment of one or more skegs 124. In various embodiments, the skeg 124 may have a generally fin-like shape. In various embodiments, the skeg 124 may have a constant thickness along its length. In various embodiments, the skeg 124 may have a varying depth along its length. For example, the skeg 124 may taper from a first, larger depth, d₁, to a second, smaller depth, d₂. In various embodiments, one side of the skeg 124 may be vertical while the other side tapers. In various embodiments, both sides of the skeg 124 may taper. In various embodiments, the skeg 124 may have a curvilinear or airfoil shape, similar to the struts 116. In various embodiments, the skeg 124 is removable and replaceable at the skeg/lower unit interface. In various embodiments, the skeg 124 can be integrally formed at the skeg/lower unit interface. In various embodiments, the skeg 124 contributes to stability and hydrodynamic flow interaction by having a trailing edge that minimizes flow disturbances going into the propeller 110. In various embodiments, the bottom-most edge of the skeg 124 may be lower than the blades of the propeller 110, providing protection to the propeller 110 from physical object strikes. Additionally or alternatively, the location of the skeg 124 can be adjusted up/down stream relative to the lower unit 114.

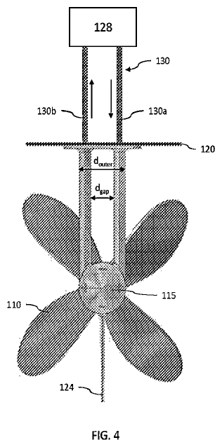

FIG. 4 illustrates a partial frontal view taken generally below the line 1-1 of FIG. 1. As shown in FIG. 4, the prime mover 128 is rotationally coupled to the belt 130 via a drive shaft (not shown). As the prime mover rotates, either the left side 130a of the belt 130 or the ride side 130b of the belt 130 may transmit rotational force to and from the propeller. In the example shown, where the belt 130 is rotating counter-clockwise (from the viewpoint of the prime mover 128), the left side 130a of the belt is the slack side and the right side 130b of the belt 130 is the taut (i.e., in tension) side. In various embodiments, the width of the gap between the two struts 116 (as measured by the distance between the inside edges of each strut) allows for passage of fluid (e.g., sea water) and can be changed to accommodate larger or smaller overall component dimensions, while keeping the ride side 130b of the belt 130 and left side 130a of the belt 130 parallel with one another. In various embodiments, the distance, d_{gap}, between the inside edges of the struts 116 can be varied based on ideal performance metrics, e.g., to reduce frontal (drag) area. In various embodiments, the distance, dₒᵤₜₑᵣ, between the outside edges can also be varied, for example, to accommodate thicker pitched belts. In various embodiments, the strut/lower unit interface may have a gradual, hydrodynamic shape to minimize flow disturbances as water travels through the struts 116 to the propeller 110. In various embodiments, the propeller 110 may be placed in front of the struts 116. In various embodiments, the anti-ventilation plate 120 may connect to the top (i.e., a proximal end) of the struts 116 and may prevent the propeller from sucking air from the surface. The anti-ventilation plate may be referred to colloquially as a “cavitation Plate”. The upper end of struts 116 can connect directly to the cowling 107; additionally or alternatively, the upper end of struts 116 can connect to a mounting plate/frame which receives the cowling 107.

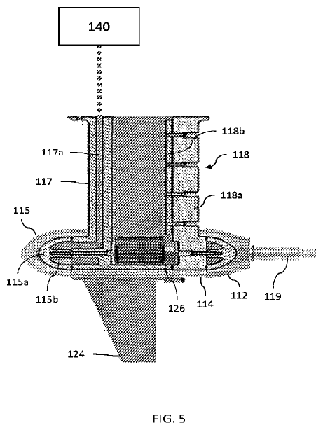

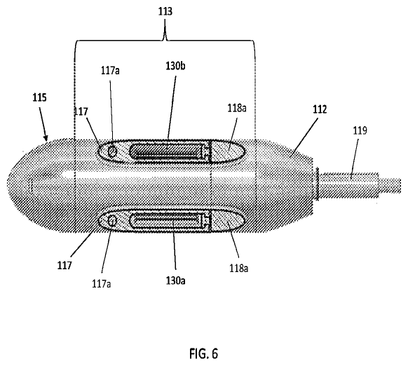

FIG. 5 illustrates a partial side view, partially in section, taken generally below the line 3-1 of FIG. 3. In various embodiments, the sprocket 126 is concentrically fixed to the propeller shaft 119, which exits the lower unit bullet through the tail fairing 112. In various embodiments, the inside of the lower unit 114 is protected from sea water through seals on all edges and interfaces, including a set of shaft seals. In various embodiments, both leading edges 117 of the struts 116 contain coolant passages 117a to allow coolant to flow therethrough. In various embodiments, coolant can enter each strut through a coolant port, then flow through the coolant passages 117a, which removes heat from the coolant through conduction. Thus, the present disclosure provides a closed-circuit fluid cooling system, wherein the coolant circulation path is retained within the struts 116, nose cone 115 and anti-ventilation plate 120. Thus the coolant system does not need to rely on the intake of ambient water when in operation. In various embodiments, the coolant passage(s) 117a of each strut allows coolant to flow into a nosecone void 115a, which acts as a submerged, heat rejecting reservoir. In various embodiments, the nosecone void 115a contains one or more nosecone turbulators 115b (e.g. undulating structure/wall/strip) configured to increase turbulence of the heat transfer fluid and thus increase heat rejection capacity. Optionally, coolant passages 117a can extend throughout the anti-ventilation plate 120.

In various embodiments, coolant can flow bi-directionally through the struts 116 and to the thermal circuit 140 via the coolant passage 117a. In various embodiments, the coolant passage 117a may comprise tubing, hosing, pipes, and/or other methods of fluid transfer. In various embodiments, the thermal circuit may include an electronic controller pump and/or heat producing components including but not limited to the power electronics and prime mover. In various embodiments, a set of coolant port seals ensures the heat transfer fluid does not become contaminated. In various embodiments, additional voids may be provided in the trailing edge(s) 118, belt accommodation void 131, tail fairing 112, and/or lower unit 114 that can be used for additional coolant passages. In various embodiments, the longitudinal width of the belt accommodation void 131 can be varied for belts of different sizes. In various embodiments, the trailing edge 118 may be mechanically fastened by a set of trailing edge fasteners 118a configured to anchor into an anchor panel 118b (e.g., a T-block). In various embodiments, this method of attachment allows the trailing edges 118 to be separated from the struts 116 for installation and removal of the belt 130. In various embodiments, the belt accommodation void 131 may be optimized such that the size (e.g., width of the void space) of the void is minimized. In various embodiments, less void space may be better from a hydrodynamic standpoint (e.g., less drag area). In various embodiments, the belt accommodation void 131 may be about ⅛ inch on either side of the belt 130. In various embodiments, the sprocket gap 125 may have a similar ⅛″ gap. In various embodiments, the sprocket gap 125 may be smaller than the space between the belt 130 and an interior side of the belt accommodation void 131 as the belt may not have as much motion around the sprocket 126. In various embodiments, the belt accommodation void 131 may include a spacing (e.g., width) of about 0.01 inch to about 0.25 inch on either side of the belt. For example, 0.25 inch on either side of the belt 130 would result in 0.25 in +0.25 in +belt thickness (in inches) for the total width of the belt accommodation void 131. In various embodiments, the belt accommodation void 131 may include a spacing (e.g., width) of about 0.01 inch to about 6 inches on either side of the belt. In various embodiments, the spacing may scale with system size. In various embodiments, the spacing (e.g., width) may be about 12 inches on either side of the belt.

FIG. 6 illustrates a partial top view, partially in section, taken generally below the line 3-1 of FIG. 3. In various embodiments, the nosecone 115 has an outer contour that maintains an attached flow (e.g., reduces/prevents boundary layer separation) with the surrounding fluid body. In various embodiments, the nosecone 115 has a conical shape. In various embodiments, the nosecone 115 may be blunt or rounded at the tip. In various embodiments, the contour can be changed to suit different operating conditions. In various embodiments, the lower unit 114 may be cylindrical in shape and connected to both struts. In various embodiments, the trailing edges 118 may be connected to the struts 116 through fasteners anchored into the T-block 118b. In turn, the T-block is held by the walls of the dual strut bodies. In various embodiments, the leading edges 117 may include a coolant passage 117a having a circular diameter. In various embodiments, the coolant passage 117a may have a substantially constant diameter throughout the thermal circuit 140.

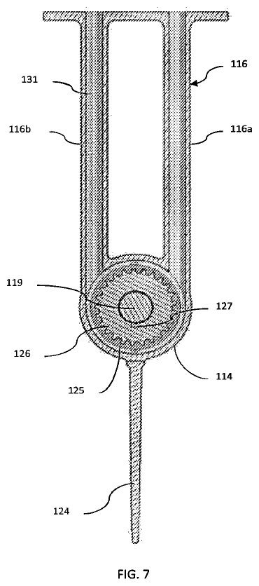

FIG. 7 illustrates a partial frontal view, partially in section, taken generally below the line 3-1 of FIG. 3. As shown in FIG. 7, the lower unit 114 and struts 116 include a belt accommodation void through which the belt 130 may pass. In various embodiments, the struts 116 include a strut inside wall and strut outside wall. In various embodiments, the strut inside wall and strut outside wall may be made of any suitable material, and can, but are not required, to be integrally formed with the rest of the strut body. In various embodiments, the thickness of the strut walls may be selected based on the application, either to increase robustness or decrease drag. In various embodiments, within the lower unit 114, the belt-driven sprocket 126 is concentric with the propeller shaft 119. In various embodiments, a keyway 127 is used to transmit torque between the sprocket 126 and propeller shaft 119. In various embodiments, a spline could be used or the sprocket 126 and propeller shaft 119 can be integrally formed. In various embodiments, to accommodate the thickness of the belt 130, an air-filled sprocket gap 125 exists in the lower unit 114. In various embodiments, due to the dual strut configuration, the belt 130 is able to rotate about the sprocket 126 without physically contacting any other part of the lower unit 114. In various embodiments, this contact-free operation allows for lubrication-free operation, compared to other motors which requires the belt or transmission components to operate in an oil-filled bath. The belt 130 can wrap around the sprocket 126, with engagement between respective surfaces over approximately 180 degrees of rotation of the sprocket. The sprocket 126 can include raised teeth, as shown, to increase the frictional engagement with the belt and generate greater torque.

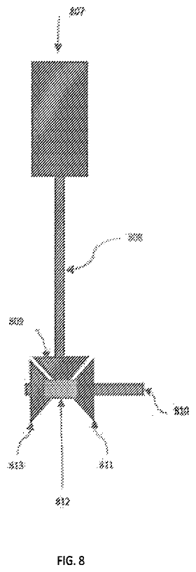

FIG. 8 illustrates a schematic representation of a traditional outboard power transmission system. In various embodiments, this utilizes a prime mover 807 with a vertically extending drive shaft 808. In various embodiments, power is transmitted from the vertical drive shaft and the horizontal prop shaft using gears. In various embodiments, a pinion gear is used 809 in conjunction with a crown gear 811 and 813 to transfer rotational velocity to the driven shaft. In many embodiments, a clutch is used with a sliding collar 812 that can engage either the clockwise or counter clockwise crown gear. In various embodiments, this mechanism enables a change in the rotation direction of the propeller shaft while maintaining drive direction of the prime mover.

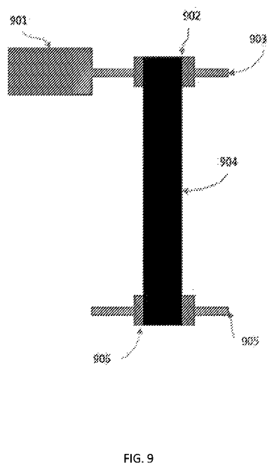

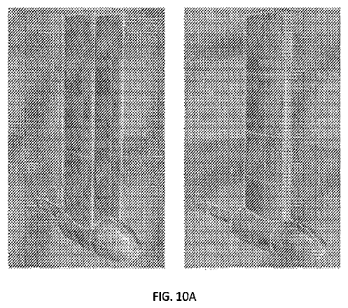

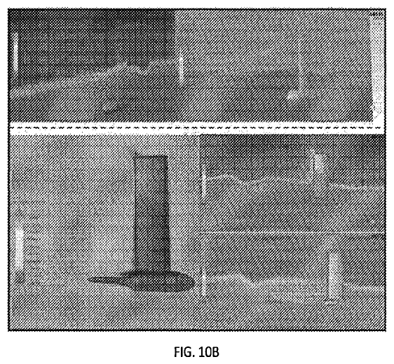

FIG. 9 illustrates a schematic representation of a belt drive transmission system. In various embodiments, this is a schematic representation of a certain embodiment for an alternative means of power transmission between a prime mover 901 and the lower driven shaft 905. In various embodiments, the prime mover utilizes a drive shaft extending horizontally 903, supporting a sprocket or gear 902, capable of driving a belt to the lower sprocket or gear 906 via a continuous loop 904.

In various embodiments, any struts may include non-linear shapes. In various embodiments, to accommodate a non-linear shape, the belt may remain substantially straight, but and the width of the belt accommodation void 131 (space between the belt and inside walls of the strut voids) may vary. In various embodiments, the struts may include pulleys (e.g., roller pulleys) configured to create a curve for the belt 130 to follow. In various embodiments, low friction pads can be positioned at any suitable position within the belt accommodation void 131. In various embodiments, any combination of the above three methods could work together to achieve a non-linear strut shape. In various embodiments, the leading edge of the struts may include a non-uniform profile (viewing from the top-down).

The various components disclosed herein (e.g., struts, nosecone, fairing, skeg) can be formed from a variety of materials including metals (e.g., aluminum, steel, titanium, etc.) rigid polymers and plastics, wood, etc. In various embodiments, the various components may include composite materials (e.g., carbon fiber, fiberglass, etc.). In various embodiments, the various components may include rubber. In various embodiments, the various components may include thermoplastics. In various embodiments, the various components may include any suitable metal-based alloys. In various embodiments, the various components may include materials with high thermal conductivity and high corrosion resistance. In various embodiments, the various components may include one or more coatings (anodize, powder coat, chemical vapor deposition, paint, etc.). In various embodiments, the various components may be formed from more than one material (i.e., nosecone could be mostly aluminum with a rubber based tip).

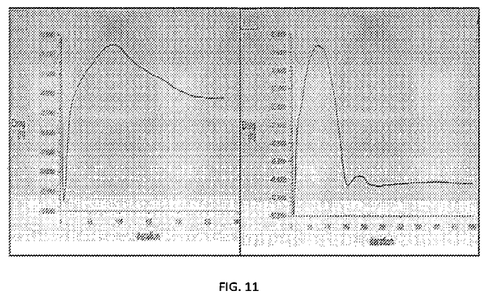

FIGS. 10A-10B illustrate a computational fluid dynamics visualization of the disclosed dual strut (top) and a traditional single strut (bottom). In various embodiments, this half-body analysis was used to understand preliminary hydrodynamic effects and implications of a dual strut compared to a single strut. The plot of FIGS. 10A-10B shows a laminar flow as evidenced by the largely uniform shading of the fluid flowrate values (the darker portion of the plot in FIG. 10B is above the water line).

FIG. 11 illustrates a graphical representation of initial computational fluid dynamics drag results of the disclosed dual strut (left) (approximately 37,500 Newtons at iteration 150) compared to a traditional single strut (right) (approximately 45,500 Newtons at iteration 150). This simulation evidences the hydrodynamic advantages of a dual strut compared to a single strut.

### Feedback Control for Variable Path Coolant Flow

The present disclosure also provides an efficient thermal management system for a propulsion system that generates waste heat as a byproduct. An intelligent, variable-flow-path cooling loop includes at least a reservoir, pump, drive module, pass-through valve, and radiator through which a working fluid is pumped. Internal cooling pipelines connect each component through a combination of series and parallel flow paths. In various embodiments an active feedback loop uses data from various inputs and sensors to access relative cooling requirements of different components and directs flow accordingly. In various embodiments thermocouples are embedded in the system to measure temperature of the fluid and surrounding area. In various embodiments thermometers are utilized to measure said temperature. In various embodiments the sensors are externally accessible for maintenance. In various embodiments the sensors are embedded in the manufacturing of the pipelines. Using single input-multi-output valves or manifolds, in conjunction with flow meters, pipelines are connected into multiple loops that can be automatically adjusted. Each loop can be selectively opened to varying degrees according to component requirements and working states of each component within the loop. The system is significant in energy saving and efficiency in heat dissipation capabilities. In various embodiments the loops are disposed proximate to heat-producing systems, such as a motor or leading edge of a moving vehicle, like the hull of a boat or the torpedo of a lower unit.

In various embodiments, the working fluid is a water-glycol mix to reduce the risk of coolant freezing and adds a control over what fluid passes through sensitive components. In various embodiments, the working fluid is water (e.g., deionized water). In various embodiments, the working fluid is an organic chemical compound (e.g., ethylene glycol, diethylene glycol, propylene glycol, polyalkylene glycol, mineral oil, silicone oil, ethanol, methanol, fuel, etc.). In various embodiments, the working fluid is a refrigerant (e.g., ammonia, R-12, R-22, R-134A, R-744, R-717, HCFC, HCS, R-407C, R-404A, R-410A, R-448A, R-449A, etc.). In various embodiments the fluid is actively cooled by one or more refrigeration-type systems in addition to or alternatively to the herein described system. For example, the fluid could dump heat when it passes through a heat sink as described herein, or be actively cooled utilizing a condenser or other known refrigeration techniques in conjunction with a refrigerant like R-134A, according to various embodiments.

A system to control the relative flow to different waste heat generating components can more efficiently dissipate heat and minimize the additional power requirements to run the pump. The present disclosure uses an array of temperature, pressure and flow rate sensors to assess cooling requirements and direct relative flow of the working fluid as needed. Furthermore, based on user input data, such as throttle percentage, the system can preemptively direct flow to particular components to slow temperature gains. For example, if a particular one or more motors are throttling up, the system may direct additional working fluid (e.g., increase working fluid volumetric flow rate) to the particular motor(s). In various embodiments the system may turn on one or more proximate loops to aid in the cooling of said throttling-up component(s). For example there may be three loops surrounding a motor that is throttling up, or be disposed within the motor or housing thereof. The system may detect a low initial temperature and have no working fluid or a single loop actively cooling said motor. The temperature may rise as the motor runs, the system, utilizing the temperature sensors, among other sensors such as pitot tubes (disposed on the hull or motor housing) or flow meters may then command the second loop to flow working fluid to the motor. In the same example, if the motor temperature continues to rise or passes a temperature threshold, the system may turn on the third loop to send working fluid toward the motor and back in an attempt to cool it. In another example, the system may not only command multiple loops actively, it may command an active refrigerant system to cool the fluid at a higher rate or to lower working temperatures to cool the motor (or other relatively hot component). In various embodiments, and in a continuation of the preceding example, the system may command all three loops to flow working fluid proximate the hot motor. In the even the temperature continues to rise, or a failure is experienced, the system may then actively cool the working fluid to sub-normal operating temperature, thereby increasing the ability to absorb the heat energy from the motor not only with a greater volumetric increase, but temperature variation. Total system flow can also be reduced when heat dissipation requirements are reduced to minimize power draw from the pump.

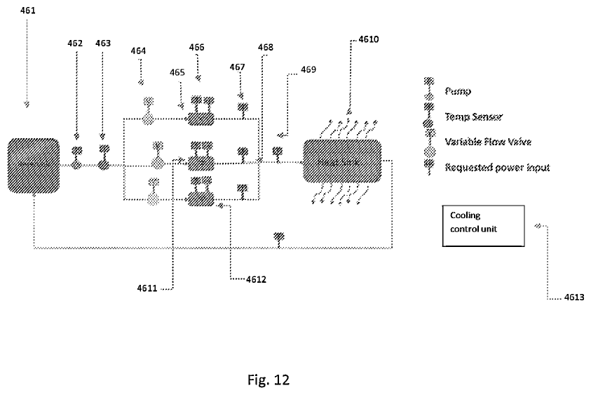

FIG. 12 depicts a schematic representation of a single pump, multi flow path cooling channel to cool a marine propulsion system. In various embodiments there may be a plurality of pumps and any other component as described herein. For example there may be a primary and secondary reservoir, or a multi-reservoir system based on cool-down times from the working fluid, for example. A reservoir 461 stores a working fluid (e.g., water) used as a heat sink for power electronics. Immediately connected to the reservoir in series is a pump 462. The pump provides a positive pressure gradient through the system and circulates the coolant. The pump contains one or more integrated flow meters connected to the central cooling control unit 4613. Connected via tubing to the output of the pumps is a temperature sensor 463. The temperature sensor measures the steady state temperature of the coolant before it reaches any heat generating components. After passing through the temperature sensor, the flow path is split from a single flow to a multi flow output. In some embodiments, this may use a single variable valve with one input and multiple output. In various embodiments this may be accomplished using a plurality of valves connected to one or more manifolds of non-limiting inputs and outputs. Each of these valves in this example may be an adjustable valve. In various embodiments a subset of valves are adjustable valves (i.e., open and close a selectable distance, percentage, amount, or like measurement). In various embodiments all of the valves are adjustable valves. In some embodiments, a flow splitter is used with an adjustable valve 464 connected to each output of the splitter. The valve 464 has an integrated flow sensor to calculate the mass flow rate through the dedicated flow path. In various embodiments the flow meter may additionally or alternatively measure flow rate volumetrically and/or temperature of said fluid embedded in a single sensor or sensor suite. Each path has one or more designated component to be cooled. In this embodiment, a motor 465, is connected in parallel with an inverter 4611 and a charger 4612. The motor 465 has an integrated thermocouple 466 that outputs to a central cooling control unit 4613, remotely or via wired connection (e.g. thermocouple 466 can be attached to the motor housing, or disposed on a stator/rotor of the motor). The output from the integrated thermocouple 466 is used to calculate the relative flow requirement along the path. If the temperature exceeds a pre-determined limit, the valve 464 will be opened further to increase flow rate. Connected to the output of the thermocouple 467 is a splitter 468 to join back each of the flow paths. For the inverter 4611 and the charger 4612, there are duplicate arrays of thermocouples and valves to measure the temperature and flow of each coolant flow path. The splitter 468 has a multi-input, single output orientation to join the flows together. Connected to the single output of the splitter is an additional thermocouple 469 that is also connected to the central cooling control unit 4613. The total thermal energy added to the flow can be calculated by measuring the change in temperature between the thermocouple 463 and thermocouple 469. The total thermal energy added to the flow path gives a value for the losses through the system and overall thermal efficiency. All the flow then passes through a heat sink device 4610. The heat sink radiates excess thermal energy into the surrounding body of water to cool the circulated fluid back to a steady state temperature. Again, connected via hosing or tubing, the fluid is returned back to the reservoir where it can be recirculated around the system.

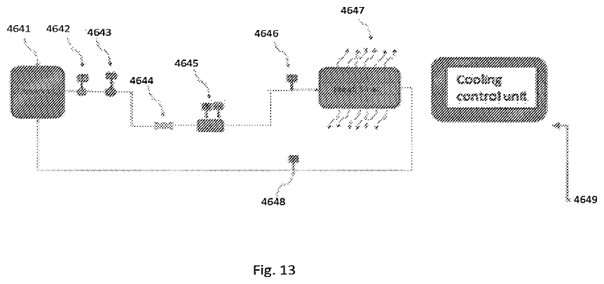

FIG. 13 is a schematic diagram of one embodiment of a cooling loop system operating to cool a high-temperature charger in charge mode. When charge mode is enabled, the central cooling control unit 4649, closes each flow path except through the charger. The reservoir 4641 holding a predetermined volume of working fluid (e.g., water) to function as a heat sink is connected in series, first to a pump 4642 and then a thermocouple 4643. When in charge mode, only valve 4644 is open allowing coolant to flow. The charger 4645 has an integrated thermocouple and outputs the speed of charging. After passing through the charger, the coolant passes through an additional thermocouple 4646 that is connected to the central cooling control unit 4649. The total waste heat generated by the charger is calculated to determine a thermal efficiency. The temperature of the charger is mapped over time to find a steady state temperature. If the temperature of the charger continues to rise above a predetermined limit, the system will increase the power to the pump to increase the flow rate and thus heat dissipation. If the charger continues to rise in temperature, the speed of charging is reduced to a point where a steady state temperature is reached below the limit of the charger. Before returning to the reservoir 4641, the coolant passes through a heat sink 4647 to dissipate the heat that has been added to the flow by the charger. Finally, in this embodiment, an additional thermocouple 4648 is added to calculate the total thermal energy being dissipated by the heat sink.

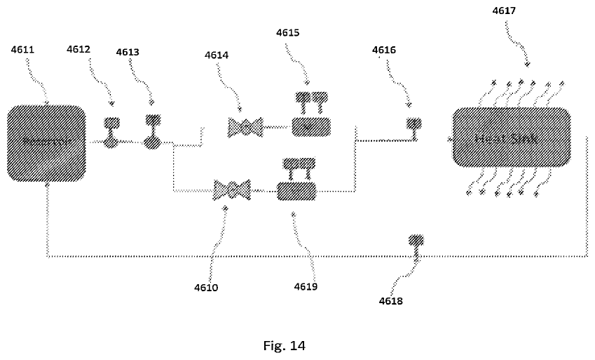

FIG. 14 is a schematic diagram of one embodiment of a cooling loop system operating to cool a high-temperature motor and inverter, bypassing the charger. A volume of working fluid (e.g., a coolant) is held in the reservoir 4611. Connected to the output of the reservoir is a pump 4612 and thermocouple 4613 to provide the pressure gradient through the system and calculate the total thermal energy. The valves 4614 and 4610 are individually controlled based on the relative temperature of the heat generating component in its respective loop. For a given operating scenario, if both the motor 4614 and inverter 4619 are within safe working temperature range, the power to the pump 4612 can be reduced to improve the overall system efficiency. If either the motor 4615 or inverter 4619 requires additional heat dissipation, a larger proportion of the flow can be directed as needed by adjusting the valves 4614 and 4610. This allows the pump 4612 to reduce the power requirements as the system more effectively diverts flow to where it is needed. The flow out of each heat generating component is brought back together before passing through an additional thermocouple 4616, to measure the total thermal input into the flow. Before returning back to the reservoir 4611, the flow passes through the heat sink 4617, to dissipate the added thermal energy into the surrounding body of water.

Integrated Motor-Gearbox with Reduced Gear Ratio

The present disclosure details the methods to constrain the planet carrier of a planetary gear box set to achieve a gear reduction ratio of 2:1 using a standard gearset that has a 3:1 reduction. Using a novel design to constrain either the sun gear or the planet carrier, it is possible to achieve a reduced gear reduction ratio. In various embodiments, the gear set is fully contained and sealed in oil to ensure sufficient cooling and lubrication. In various embodiments, the housing is designed such that there is no additional diameter added to the motor-gearbox drivetrain. When using a single stage, it is possible to have ratios from 3:1 to 10:1. Additional stages can be added to increase the ratio.

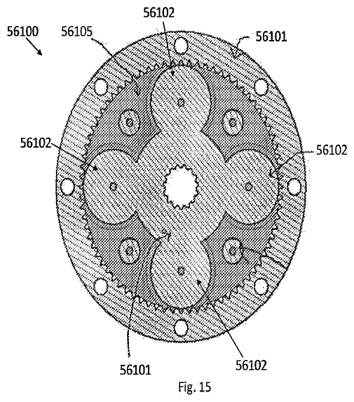

FIG. 15 shows a cross sectional view of a planetary gear set 56100. The outer ring gear 56101 has a through-hole, circular pattern, typically used to constrain the ring. The teeth of the ring gear 56101 mesh with each of the planet gears 56102. The planet gears 56102 can be equidistant apart from each other and equiangularly disposed around the planet carrier 56105. The planet gears 56102 also mesh with the central sun gear 56104. The ratio of tooth count between the sun gear 56104, planet gears 56102 and ring gear 56101 determine the output ratio of the gearbox. In various embodiments, set screws fix the outer diameter of the planet carrier 56105 to an output spline that is configured to couple to another component (e.g., an output shaft) thereby transferring rotational motion from the input shaft to the output spline.

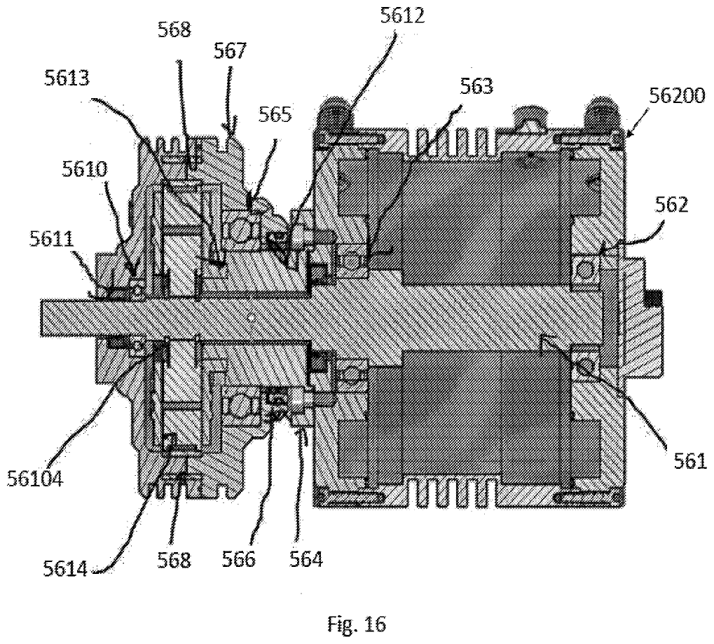

FIG. 16 shows the side profile sectional half view of a motor in line with a gear reduction assembly. The motor shaft 561 is affixed with a bearing 562 at the rear of the motor 56200 and a second bearing 563 at front of the motor. Two or more bolts 564 attaches a spacer 5612 against the motor body via mounting holes 569. In various embodiments, the spacer is configured to hold the planet carrier fixed at a connection point 5613. The shaft 561 from the motor passes through the center of the bearing carrier, meshes with the sun gear 56104, and is axially constrained using snap rings 56104. The gear set is flipped 180 degrees such that the sun gear 56104 is not on the input side of the planetary gearset 56100, but the output side. The motor spacer 5612 has a bearing 565 pressed over the outer diameter to increase rigidity of the rotating body. The bearing 565 is held in a pocket bore of the input side of the gearset housing 567. Both the input and output halves of the gearset housing 567 have locating dowels 568 to keep accuracy between each body. In various embodiments, the output portion of the gearset housing 567 has an additional bearing 5610 to ensure radial alignment with the center rotating axis. In various embodiments, the planetary gearset 56100 is contained in a closed volume within the gearset housing 567. In various embodiments, the planetary gearset 56100 is submerged in oil for lubrication and cooling. At least one input seal 566 and at least one output seal 5611 are added around the shaft on the input and output sides to limit any oil loss along the shaft 561.

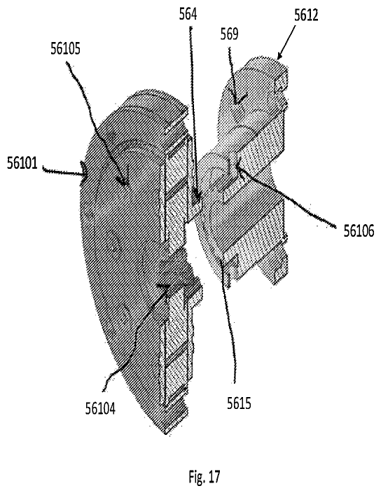

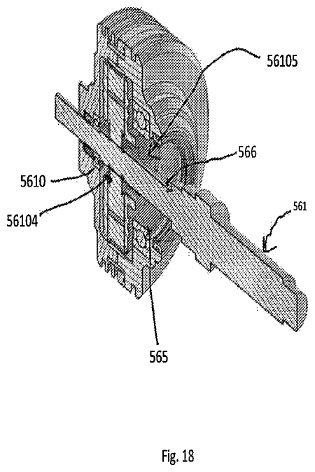

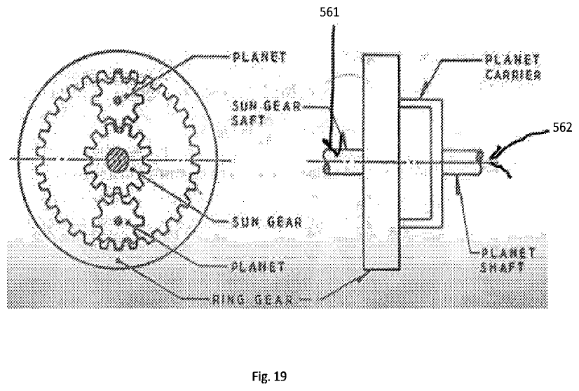

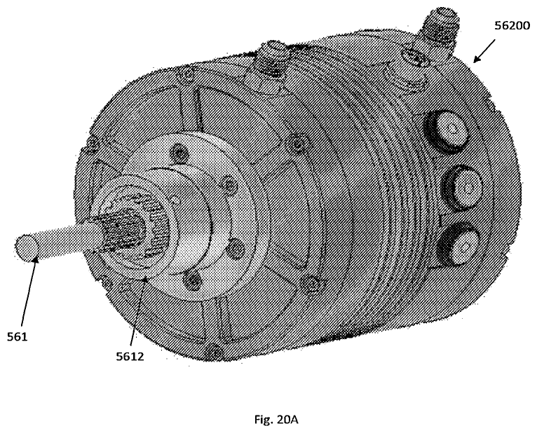

FIG. 17 shows an isolated, exploded, sectional half view of the planetary gearset 56100 and a spacer 5612 used to constrain the planet carrier 56105. The circular pattern of countersunk holes 569 are used to align and fix to an input motor. The gearset 56100 has two internal splines, one in the central sun gear 56104 and the second to mesh with the spacer 5612. The spacer 5612 has a corresponding male spline 5615 to mesh with the planet carrier 56105. There are additional set screws 56106 to fix the outer diameter of the planet carrier spline. In this setup, the outer ring 56101 is free to rotate with the sun gear 56104 driven by a motor.

FIG. 18 shows a sectional half view with the input motor and motor spacer removed for clarity. The motor shaft 561 is splined 566 to mesh with the input sun gear 56104. The shaft passes through the larger female spline of the planet carrier 56105. The exterior housing is free to spin and is radially located to the shaft with bearings 565 and 5610. The inner diameter of bearing 565 is mounted directly to the motor shaft 561. The input side bearing 565 is radially located to the motor spacer to ensure consistent alignment.

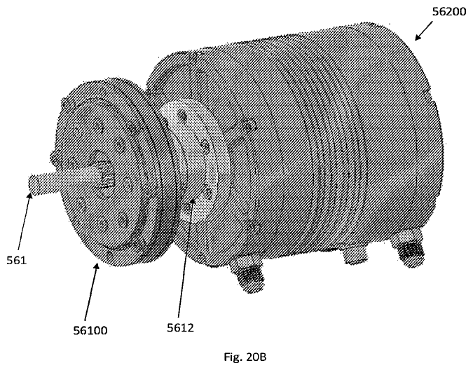

FIG. 19 shows a simplified labeled schematic of a planetary gear set. The motor (input) shaft 561 is connected to a central sun gear. Each of the planets are connected by a planet carrier 562 to an output shaft 5614.

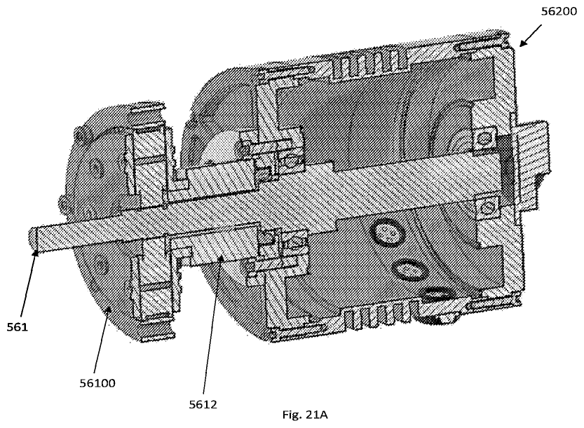

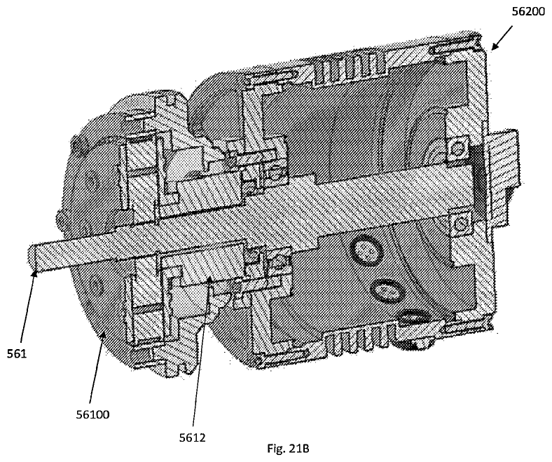

FIG. 20A illustrates a motor 56200 having a shaft 561 with a spacer 5612 coupled to the exterior of the motor 56200. FIG. 20B illustrates a planetary gearset 56100, spacer 5612, and a motor 56200.

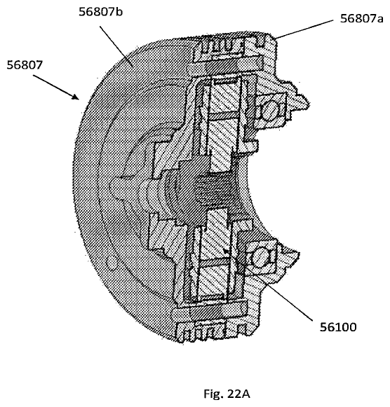

FIG. 21A illustrates a cross-sectional view of a planetary gearset, a spacer, and a motor. FIG. 21B illustrates a cross-sectional view of a gearset housing coupled to the carrier and a motor.

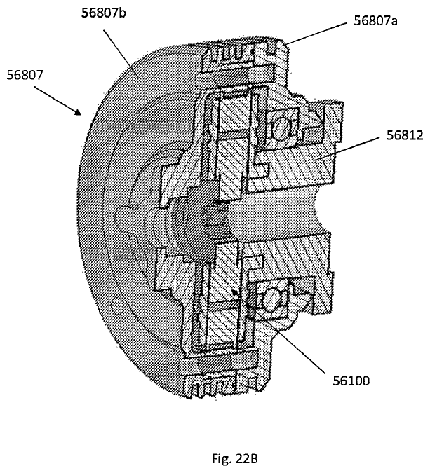

FIG. 22A illustrates a cross-sectional view of a planetary gearset 56100. FIG. 22B illustrates a cross-sectional view of a planetary gearset and gearset spacer 56812. As shown in FIGS. 22A and 22B, the planetary gearset 56100 includes a proximal portion 56807a and a distal portion 56807b of a gearset housing (collectively, 56807). In various embodiments, the gearset housing 56807 substantially encloses the planetary gearset 56100. In various embodiments, the gearset housing 56807 includes a fluid configured to cool and/or lubricate the planetary gearset 56100.

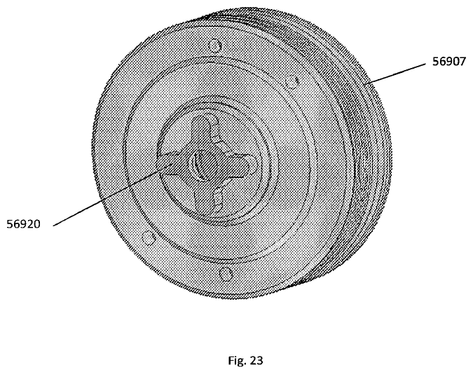

FIG. 23 illustrates a gearset housing 56907 with the output spline 56920 highlighted. In various embodiments, the gearset housing 56907 is coupled to the carrier of the planetary gearset (not shown) and is configured to rotate at a different (e.g. slower) RPM than the input shaft from the motor. As shown in FIG. 23, the housing is generally cylindrical in shape and includes a spline 56920 on a distal (away from the motor) side. In various embodiments, the spline 56920 is configured to rotationally couple the gearset housing 56907 to another rotational component (e.g., an axle) of the system. In various embodiments, the spline 56920 includes a male spline that protrudes outwardly (e.g., is extruded) from the surface of the gearset housing 56907. In various embodiments, the spline 56920 includes a female spline that is formed (e.g., an extruded cut) into the surface of the gearset housing 56907. In various embodiments, the spline 56920 is formed having a central bore aligned with the input shaft of the motor. In various embodiments, the input shaft of the motor extends through the spline 56920. In various embodiments, the spline 56920 may include any suitable shape configured to transfer rotational motion from the gearset housing 56907 to another rotational component. For example, as shown in FIG. 23, the spline 56920 includes a plus shape.

### Actively Cooled Epicyclic Gearing

The present disclosure details systems and methods for dissipating heat more effectively from a planetary gearbox using novel designs for heat sink geometries. The improved dissipation allows the gearbox to operate in a continuous regime at higher revolutions per minute (RPM), thereby transmitting more power over time. Within the gearset of a planetary gearbox, the bearings in each of the planet gears are a point of local heat concentration. Using a heat sink that is spatially closer to the bearings and flowing a coolant across the face of the gears, instead of only the outer diameter, more heat can be pulled from the gears. Further advantages include more compact design and lower weight, increasing the power to weight ratio. This system can be seamlessly integrated into a pre-existing coolant loop to reduce complexity. In various embodiments, the system may be implemented in a boat motor. In various embodiments, the system may be disposed in a boat transmission. In various embodiments the system may be implemented in one or more locations on a watercraft, such as multiple instances in a transmission, larger gearbox or drivetrain. In various embodiments, the planetary gearbox may be disposed at a plurality of orientations in space, such as horizontal relative to the overall gearbox, vertical, disposed at an angle, or the like.

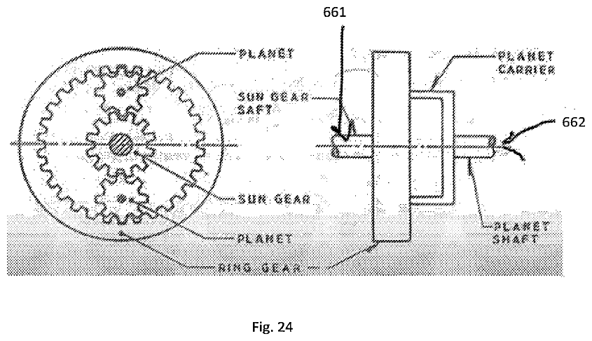

FIG. 24 shows a simplified labeled schematic of a planetary gear set. The input shaft 661 is connected to a central sun gear. Each of the planets are connected by a planet carrier to an output shaft 662. In various embodiments, the central sun gear is fixed and one or more other components are configured to rotate and/or revolve relative to said fixed point. In various embodiments the ring gear may be fixed and the other components may be configured to rotate and/or revolve relative to said ring gear. In various embodiments, another component to which the system is affixed may be fixed in space and the planetary gearbox may be configured to revolve and rotate relative to said outside point.

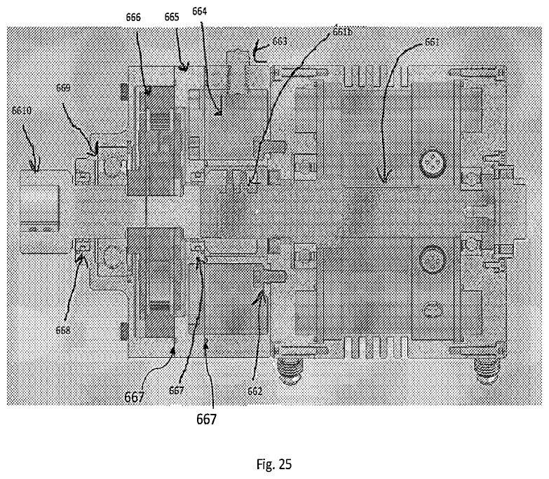

FIG. 25 shows a cross sectional view, down the center of a motor and gearbox drivetrain. In various embodiments, the motor is an electric motor. The shaft 661 extends from the motor and engages with the central sun-gear of the gearbox. In various embodiments, as shown in FIG. 25, the sun-gear is directly coupled to the shaft via a spline. In various embodiments, the sun-gear is coupled using a shaft adapter 661b. A toroidal shaped coolant reservoir 664 is mounted to the motor 662 and surrounds the input shaft of the gearbox 661b. The reservoir has coolant ports 663 to circulate fresh coolant across the diameter of the gearset 666. A mounting plate 665 is used to locate the gearset onto the input shaft 661b and to separate the oil and coolant volumes. A radial shaft seal 667 (e.g., O-ring) keeps the oil local to the gearset 666 and prevents mixing of the coolant and lubricating oil. A second radial shaft seal 668 is used to contain the oil from leaking from around the output shaft 6610 of the gearbox. An output bearing 669 is used to locate the output shaft in-line with the input shaft to minimize any additional wear on the gears. This design allows the coolant in the volume 664 to be much closer to the gear set and more effectively dissipate heat.

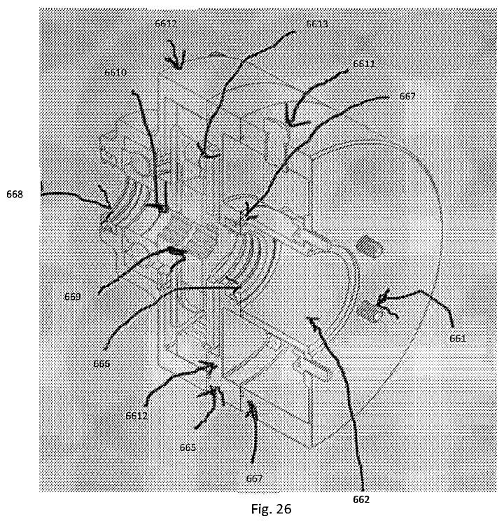

FIG. 26 shows an isometric view of the gearbox with integrated coolant housing. The input motor, input shaft and output shaft have been removed for clarity. A circular pattern of bolts with sealing heads 661 are used to affix the input side of the gearbox to the motor. The coolant volume is toroidal in shape with a center aperture 662 through which the input shaft extends. The benefit of the toroidal reservoir 664 being adjacent to, but fluidically separated from, the planetary gearset is to keep coolant close to the input shaft to draw heat from the output shaft of the motor and the input shaft of the gearbox, which drives the central sun gear 669. The toroidal reservoir 664 has a separator plate 665 with seals 667 to keep the coolant contained except for the input and output ports 6611. The separator plate 665 is used as a thin boundary 6612 between the fluid volumes of the oil and coolant. The gearset is held to the separator plate 665 using a circular pattern of bolts 6613. The volume around the gearset is sealed with a cover 6612 and a radial seal around the output shaft 668. The output shaft is located to the center of the gearset with a bearing 6610.

### Automatic Power Transmission Belt Tensioning System of a Marine Propulsion System

In order to enable the use of a belt for power transmission between the prime mover and propeller shaft, a structure holding the prime mover is affixed to and lifted or adjusted relative to the midsection by a set of lifting screws. Equal adjustment of the lifting screws allows for tensioning of the belt by moving the powerhead uniformly relative to the midsection, while uneven adjustment will tilt the powerhead, including the shafting so that it can be aligned with the propeller shaft. Connecting a motor to each set of lifting screws allows for them to be electronically controlled. Force sensors at each lifting screw can be used in to determine the tension in the belt as well as the belt alignment. The sum of the force measured minus the weight of the powerhead will give the total belt pull, equal to twice the tension, and the distribution of the force between the sensors can be used to calculate the position of the belt relative to the lifting screws. Sensor information can then be used in controlling the lifting screws to ensure proper belt tension and alignment.

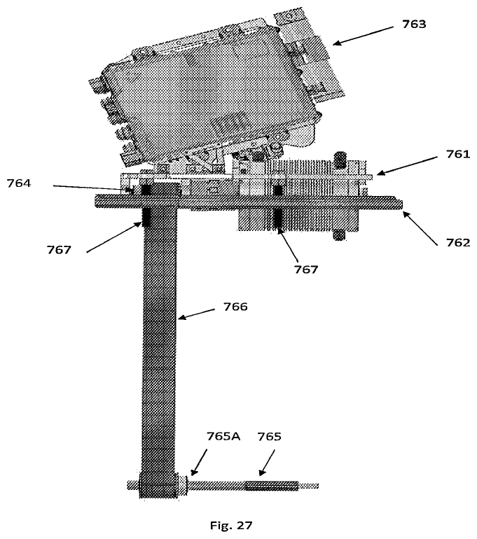

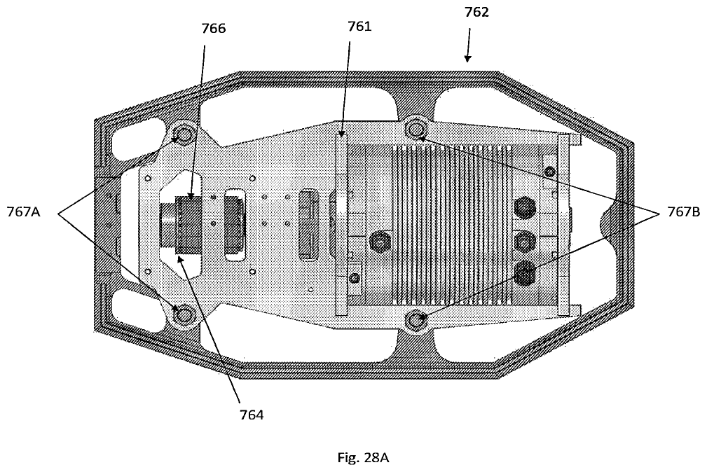

FIG. 27 shows a side view of a drive train of an outboard engine. In various embodiments, the engine may be an electric boat motor. The main lifting plate 761 is supported from the midsection top collar 762. The main lifting plate 761 supports the powerhead 763, including the driveshaft with drive sprocket 764. The drive sprocket 764 transmits power to the propeller shaft sprocket 765A through a synchronous belt 766. In various embodiments, the propeller shaft sprocket 765A rides on the propeller shaft 765. The position of the propeller shaft 765 is fixed with reference to the midsection top collar 762. The main lifting plate 761 is supported via two or more lifting screws 767. For example, the lifting plate 761 may be coupled to the top collar 762 using four lifting screws (two on each side). The further the main lifting plate 761 and accompanying drive sprocket 764 is lifted away from the midsection collar 762, the greater the tension in the synchronous belt 766. Uneven adjustment of the lifting screws 767 may vary the alignment between the drive sprocket 764 and the propeller shaft sprocket 765A. When the drive sprocket 764 and prop shaft sprocket 765A are aligned, the belt 766 can be made to run in the middle of the drive sprocket 764 without drifting to either side.

By intelligently controlling the height of the drive sprocket 764 via tensioning screws 767, the tension in the belt 766 can be controlled and set to only what is needed for the given power transmission requirements, therefore reducing frictional losses.

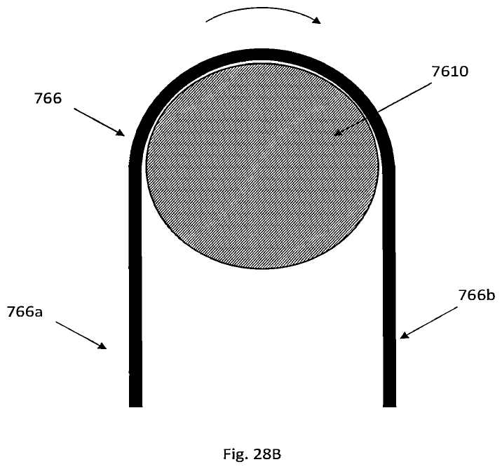

FIG. 28A shows a top view of the powerhead 763 and midsection top collar 762 with several powerhead components hidden to provide a clear view of the lifting screws 767. In various embodiments, the lifting screws 767 can be split into two or more groups. For example, the lifting screws can be split into front lifting screws 767A and rear lifting screws 767B. Within each group of lifting screws 767A and 767B, movement of the screws will be synchronized to maintain side to side levelness of the main lifting plate 761. By measuring the load placed on each set of lifting screws 767A and 767B compared to the total load on all lifting screws 767, the position of the belt 766 on the drive sprocket 764 can be determined. Uneven adjustment of the front lifting screws 767A and rear lifting screws 767B can allow for the drive sprocket 764 to be tilted without altering its vertical position. When one end is raised, the belt will move away. This method can be used to center the belt on the drive sprocket 764, ensuring alignment with the propeller shaft sprocket (not shown).

FIG. 28B illustrates a cross-sectional view of the belt 766 and motor shaft 7610. In various embodiments, as the shaft 7610 of the motor rotates in a direction (e.g., clockwise), one side 766a of the belt 766 is in tension (a tight side) and the other side 766b of the belt 766 is not in tension (a slack side). In various embodiments, load cells positioned below the lifting plate do not receive substantially the same forces (and thus, do not show substantially the same loads) during operation of the motor. In various embodiments, load cells on one portion (e.g., half) of the lifting plate 761 corresponding to the tight side 766a of the belt 766 receive higher forces (compressive) when compared to load cells on another portion (e.g., half) of the lifting plate 761 corresponding to the slack side of the belt 766. This is due to the reaction forces between the lifting screws on the tight side of the belt against the lifting plate that balance out the moment generated by tension of the belt 766 (as torque is applied to the belt 766).

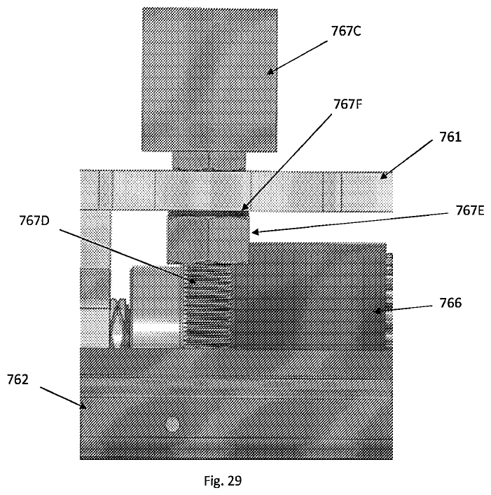

FIG. 29 shows a close-up view of a lifting screw with actuator and sensor installed. A rotary actuator 767C is configured to turn the threaded rod 767D upon activation. In various embodiments, the actuator 767C may be bidirectional (i.e., can rotate clockwise and counterclockwise). Rotation of the threaded rod 767D will cause the rod to thread into or out of the midsection top collar 762 and will adjust the height of the lifting platform 767E on which the main lifting plate 761 rests. Between the lifting platform 767E and the main lifting plate 761 is a load cell 767F configured to measure how much force is exerted downwards onto the lifting platform 767E by the main lifting plate 761.

### Onboard High Voltage Battery Charging System of an Outboard Marine Propulsion System

Onboard battery chargers (OBC) can be included in all forms of electric vehicles in which the current invention is incorporated. The OBC accepts alternating current and provides a direct current to the electric boat for charging, generally using an inverter that converts AC to DC (e.g., converts the sinusoidal AC to approximate a constant DC). In various embodiments, such as boats, the OBC is generally a separate component that is incorporated into the dock slip (i.e., not connected to the boat). Moreover, the OBC is generally fan-cooled and consumes significant energy to maintain (e.g., cool to) an operating temperature while charging.

The various embodiments described by this disclosure provide for OBCs integrated into the outboard motor of an electric boat. In various embodiments, the OBC is disposed within the housing of the outboard motor. In various embodiments, the OBC is integrated into the same thermal management system (e.g., a closed heat transfer circuit) as other heat producing components of the marine propulsion system, (e.g., the electric motor, inverter, etc.). Integration of the OBC into the outboard motor allows for AC power to be plugged directly into the outboard motor and does not create additional waste heat near components that could be damaged such as the batteries. In various embodiments, the batteries are stored within the hull of a boat.

In this system, a pump is used to supply coolant to the inverter, motor, and OBC. In various embodiments, the OBC does not require cooling at the same time as the inverter and the motor because charging from an AC power source will only occur when the vehicle is stationary and plugged in to the AC power source. In various embodiments, the heat transfer circuit includes a valve configured to allow flow to or restrict coolant flow from the OBC.

When coolant is needed to cool the OBC (e.g., during recharging), the pump will be powered, and a valve will allow coolant to flow through the OBC. When the coolant is not needed by the OBC (e.g., during operation of the motor), the valve is closed thereby restricting coolant flow to the OBC. In various embodiments, the coolant bypasses the inverter and motor while the vehicle charges. In various embodiments, the coolant flows through the heat exchanger and releases heat to the surrounding water (e.g., ocean). Potential cooling capacity will be lower due only a portion of the coolant passing through the OBC to the lack of flow over the heat exchanger that would come from movement of the vehicle through the water. In various embodiments, the OBC produces less waste heat than the motor and inverter.

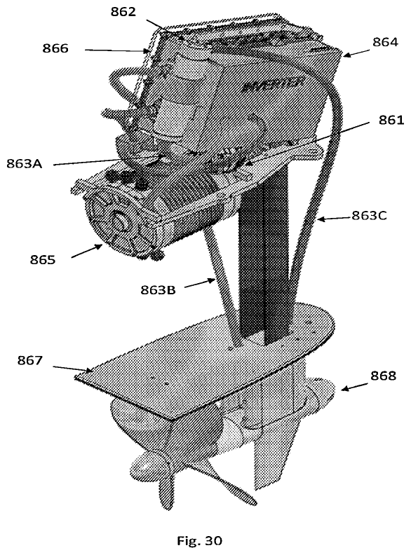

FIG. 30 shows an isometric view of the cooling loop of an outboard engine. A pump 861 moves coolant throughout the components of the outboard motor. Coolant flows from the coolant reservoir 862 though the reservoir-to-pump-tubing 863A. From here, coolant flows through the power electronics, including the inverter 864, motor 865, and OBC 866 before flowing though the powerhead-to-lower-unit-tube 863B and into the anti-ventilation plate (AVP) 867, and lower unit (LU) 868 where heat exchange with the surrounding water occurs. Now cooled, the coolant flows through the coolant return cubing 863C and back into the coolant reservoir.

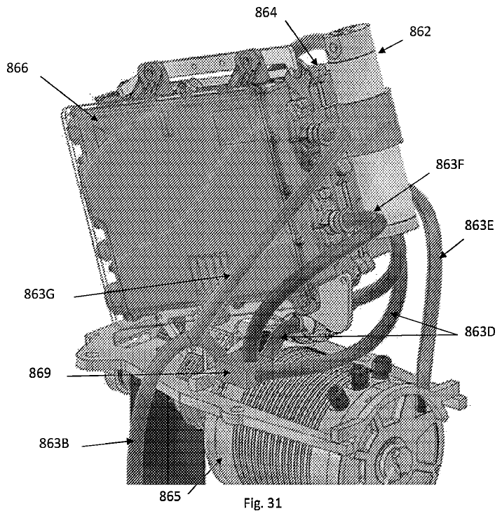

FIG. 31 shows an isometric view of the cooling loop of an outboard engine powerhead. From the pump 861, the coolant flows to the inverter 864 through the pump-to-inverter tubing 863D. After passing through the inverter 864, the coolant flows to the motor 865 through the inverter-to-motor tubing 863E. The motor coolant output is connected to the powerhead-to-LU tube 863B. When in charge mode, a solenoid valve 869 opens to allow coolant to flow from the pump-to-inverter tubing 863D into the OBC-cold-side tube 863F, through the OBC 866, and into the OBC-hot-side tube 863G which tees into the powerhead-to-LU tube 863B. When not in charge mode, the alternate coolant route through the OBC 866 is closed and does not impair coolant flow. When the solenoid valve 869 opens, coolant will have the option of flowing either through the OBC 866, or through both the inverter 864 and motor 865. The lower pressure drop in the coolant path flowing though the OBC 866 will cause a greater share of the coolant flow to go through the OBC 866 before continuing though the heat exchanger and back into the reservoir 862.

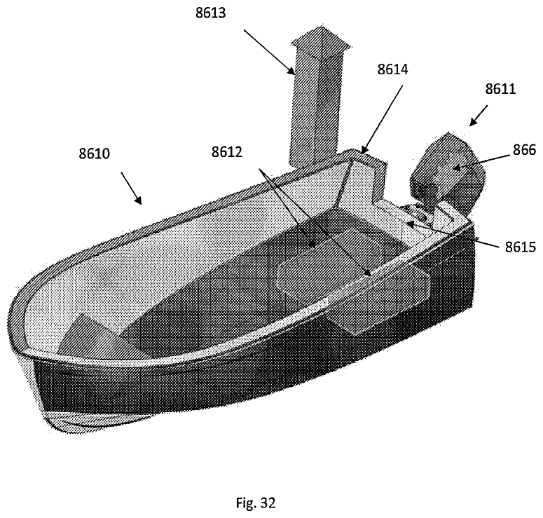

FIG. 32 shows an isometric view of a boat 8610 with an outboard motor 8611. The OBC 866 and high voltage batteries 8612 highlighted. The boat 8610 is docked next to an AC power supply 8613. An AC power cable 8614 runs from the AC power supply 8613 to the outboard motor 8611. The AC power is routed to the OBC 866 where it is converted to the appropriate DC voltage and transferred to the high voltage batteries 8612 through a DC power cable 8615. Power stored in high voltage batteries 8612 can then be used to run the outboard motor 8611.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A heat transfer apparatus comprising:
a reservoir configured to contain a working fluid;
a pump fluidically coupled to the reservoir;
a splitter fluidically coupled to the pump and coupled to a plurality of fluid flows;
a first temperature sensor disposed between the pump and the splitter, the first temperature sensor configured to measure a first temperature of the working fluid;
wherein at least one of the plurality of fluid flows includes:
an adjustable valve;
a motor fluidically coupled to the adjustable valve;
a second temperature sensor integrated into the motor, the second temperature sensor configured to measure a second temperature of the motor;
a third temperature sensor disposed downstream of the motor, the third temperature sensor configured to measure a third temperature of the working fluid;
a combiner fluidically coupled to each of the plurality of fluid flows and configured to combine each of the plurality of fluid flows;
a fourth temperature sensor disposed after the combiner, the fourth temperature sensor configured to measure a fourth temperature of the working fluid; and
a heat sink fluidically coupled to the combiner and the reservoir;
wherein the second temperature sensor is configured to provide a control signal to a control unit to thereby control fluid flow through at least one of the adjustable valves.

2. The apparatus of claim 1, wherein the heat transfer apparatus is integrated into a marine propulsion system.

3. The apparatus of claim 1, wherein at least one motor is coupled to an inverter.

4. The apparatus of claim 1, wherein at least one motor is coupled to a charger.

5. The apparatus of claim 1, further comprising a fifth temperature sensor disposed downstream of the heat sink, the fifth temperature sensor configured to measure a fifth temperature of the working fluid.

6. The apparatus of claim 1, wherein the adjustable valve is a continuously adjustable valve.

7. The apparatus of claim 1, wherein the working fluid is a refrigerant.

8. The apparatus of claim 1, wherein the working fluid is a water-glycol mix.

9. The apparatus of claim 1, wherein the splitter is a manifold.

10. The apparatus of claim 1, wherein the multiple outputs of the splitter are each coupled to an adjustable valve, each of the adjustable valves further comprising a flow sensor.

11. The apparatus of claim 1, wherein each of the adjustable valves are individually controlled.

12. A gearing system comprising:
a motor having a shaft, the shaft extending from the motor to a terminal end external to the motor;
a planetary gear set comprising a sun gear, two or more planet gears coupled to a carrier, and a ring gear, the planetary gear set having a proximal side facing towards the motor and a distal side facing away from the motor, wherein the sun gear is disposed on the distal side;
a housing enclosing the planetary gearset, the housing coupled to the ring gear; wherein:
the axle extends at least partially through the housing and the planetary gearset, and the shaft is coupled to the sun gear; and
when the shaft rotates at a first revolutions per minute (RPM), the housing rotates at a second RPM that is less than the first RPM.

13. The gearing system of claim 12, further comprising a spacer disposed on the shaft and between the planetary gear set and the motor.

14. The gearing system of claim 12, wherein the carrier is coupled to the spacer.

15. The gearing system of claim 12, wherein a ratio between the first RPM and the second RPM is 2.

16. A system comprising:
a motor;
an input shaft extending from the motor to a terminal end;
a planetary gearset adjacent and in contact with the reservoir, the planetary gearset comprising a sun gear, two or more planet gears coupled to a carrier, a ring gear, and an output shaft, wherein the input shaft is coupled to the sun gear and the output shaft is coupled to the carrier; and
a reservoir disposed between the motor and the planetary gearset, the reservoir comprising a toroidal shape around the input shaft, wherein the reservoir is fluidically isolated from the shaft and the planetary gearset.

17. A marine propulsion apparatus comprising:
a first drive shaft;
a lifting plate fixed relative to the first drive shaft;
a midsection top collar;
a first strut extending from a proximal end to a distal end and a second strut extending from a proximal end to a distal end, each of the first strut and the second strut having an interior belt void, wherein the first strut is aligned with the second strut and the first strut is spaced from the second strut, wherein the proximal ends of the first strut and the second strut are coupled to the midsection top collar;
a lower unit coupled to the distal ends of the first strut and the second strut, the lower unit having a second drive shaft, wherein the midsection top collar is fixed relative to the second drive shaft;
a belt rotatably coupling the first drive shaft to the second drive shaft, wherein a first portion of the belt is disposed within the interior belt void of the first strut and a second portion of the belt is disposed within the interior belt void of the second strut;
one or more lifting screws coupling the lifting plate to the midsection top collar, wherein adjusting the one or more lifting screws changes a distance between the lifting plate and the midsection top collar, thereby adjusting a tension of the belt; and
an actuator disposed on each of the one or more lifting screws.

18. The marine propulsion apparatus of claim 17, further comprising:
a lifting platform disposed between the lifting plate and the midsection top collar; and
a load cell contacting the lifting plate and the lifting platform.

19. A system comprising:
an electric boat motor;
a lower unit coupled to the electric boat motor, the lower unit comprising a propeller;
an inverter;
an onboard battery charger coupled to the inverter and one or more high-voltage batteries;
a heat transfer circuit comprising:
a reservoir having a working fluid;
a pump;
a valve;
a first tube fluidically coupling the reservoir to the pump;
a second tube fluidically coupling the pump to the valve;
a third tube fluidically coupling the valve to the inverter;
a fourth tube fluidically coupling the valve to the onboard battery charger;
a fifth tube fluidically coupling the inverter to the motor;
a sixth tube fluidically coupling motor to the lower unit;
a seventh tube fluidically coupling the onboard battery charger to the sixth tube;
an eighth tube fluidically coupling the lower unit to the reservoir;
wherein:
when in a charging configuration, the valve allows working fluid to flow through the fourth tube to the onboard battery charger; and
when in an operational configuration, the valve does not allow working fluid to flow through the fourth tube.

20. A method of recharging an electric boat, the method comprising:
providing an electric boat having a hull, an outboard motor coupled to the hull, and one or more rechargeable batteries disposed within the hull, wherein the outboard motor comprises an electric motor and an onboard battery charger; and
coupling the onboard battery charger to a source of alternating current thereby causing the one or more rechargeable batteries to charge.
